(19) United States
(12) Patent Application Publication
(10) Pub. No.: US 2026/0264542 A1
(43) Pub. Date: Sep. 10, 2026

(54) MODULAR SYSTEM FOR DYNAMIC TOW AND REGENERATIVE BRAKING OF A TRAILER

(71) Applicant: Range Energy Inc., Mountain View, CA (US)

(72) Inventors: Simon Rowe, Palo Alto, CA (US); Robert Alan Ng, Los Altos, CA (US)

(21) Appl. No.: 19/666,477

(22) Filed: May 4, 2026

Related U.S. Application Data
(63) Continuation-in-part of application No. 18/941,813, filed on Nov. 8, 2024.
Application No. 18/941,813 is a continuation-in-part of application No. 18/388,474, filed on Nov. 9, 2023, now Pat. No. 12,162,363.
Application No. 18/388,474 is a continuation-in-part of application No. 18/238,405, filed on Aug. 25, 2023.
Application No. 18/238,405 is a continuation-in-part of application No. 18/238,408, filed on Aug. 25, 2023, now Pat. No. 11,965,795.
Application No. 18/238,408 is a continuation-in-part of application No. 18/238,415, filed on Aug. 25, 2023.
(60) Provisional application No. 63/401,030, filed on Aug. 25, 2022.
(60) Provisional application No. 63/401,030, filed on Aug. 25, 2022.
(60) Provisional application No. 63/401,030, filed on Aug. 25, 2022.
(60) Provisional application No. 63/420,469, filed on Oct. 28, 2022.
(60) Provisional application No. 63/420,469, filed on Oct. 28, 2022.
(60) Provisional application No. 63/420,469, filed on Oct. 28, 2022.
(60) Provisional application No. 63/431,273, filed on Dec. 8, 2022.
(60) Provisional application No. 63/431,273, filed on Dec. 8, 2022.
(60) Provisional application No. 63/431,273, filed on Dec. 8, 2022.
(60) Provisional application No. 63/798,891, filed on May 2, 2025.

(51) Int. Cl. B60L 50/60; B60K 1/04; B60L 7/10; B62D 53/06; B62D 59/04

(52) U.S. Cl. CPC B60L 50/66; B60K 1/04; B60L 7/10; B62D 59/04; B60K 2001/0438; B60K 2001/0444; B60L 2200/28; B62D 53/06

(57) ABSTRACT

One variation of a system includes a kit including: a driven axle configured to install on a trailer; a motor coupled to the driven axle; and a battery assembly configured to install on the trailer. The battery assembly includes: a set of cross members; a set of batteries arranged between the set of cross members; a set of clamps; and a set of fasteners. Each clamp in the set of clamps is: pivotably coupled to a cross member in the set of cross members; and configured to couple the battery assembly to a pair of adjacent beams of the trailer to suspend the battery assembly below the trailer. Each fastener in the set of fasteners is configured to: extend through a cross member in the set of cross members; and couple a clamp, in the set of clamps, to the cross member.

### CROSS-REFERENCE TO RELATED APPLICATIONS

This Application claims the benefit of U.S. Provisional Application No. 63/798,891, filed on 2 May 2025, which is incorporated in its entirety by this reference.

This Application is a continuation-in-part application of U.S. patent application Ser. No. 18/941,813, filed on 8 Nov. 2024, which is a continuation-in-part application of U.S. patent application Ser. No. 18/388,474, filed on 9 Nov. 2023, which is a continuation-in-part application of U.S. patent application Ser. No. 18/238,405, filed on 25 Aug. 2023, Ser. No. 18/238,408, filed on 25 Aug. 2023, and Ser. No. 18/238,415, filed on 25 Aug. 2023, each of which claim the benefit of U.S. Provisional Application Nos. 63/401,030, filed on 25 Aug. 2022, 63/420,469, filed on 28 Oct. 2022, and 63/431,273, filed on 8 Dec. 2022, each of which is incorporated in its entirety by this reference.

### TECHNICAL FIELD

This invention relates generally to the field of overland trucking and, more specifically, to a new and useful system and method for dynamic tow and regenerative braking in the field of overland trucking.

### BRIEF DESCRIPTION OF THE FIGURES

FIGS. 1A, 1B, and 1C are schematic representations of a system;

FIG. 2 is a block diagram of one variation of the system;

FIGS. 3A, 3B, 3C, and 3D are schematic representations of one variation of the system;

FIGS. 4A, 4B, and 4C are schematic representations of one variation of the system;

FIGS. 5A, 5B, 5C, and 5D are schematic representations of one variation of the system;

FIGS. 6A, 6B, 6C, and 6D are schematic representations of one variation of the system;

FIG. 7 is a schematic representation of one variation of the system;

FIG. 8 is a block diagram of one variation of the system;

FIG. 9 is a schematic representation of one variation of the system;

FIG. 10 is a schematic representation of one variation of the system;

FIG. 11 is a schematic representation of one variation of the system;

FIG. 12 is a schematic representation of one variation of the system;

FIGS. 13A and 13B are schematic representations of one variation of the system;

FIGS. 14A and 14B are schematic representations of one variation of the system; and

FIGS. 15A, 15B, and 15C are schematic representations of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

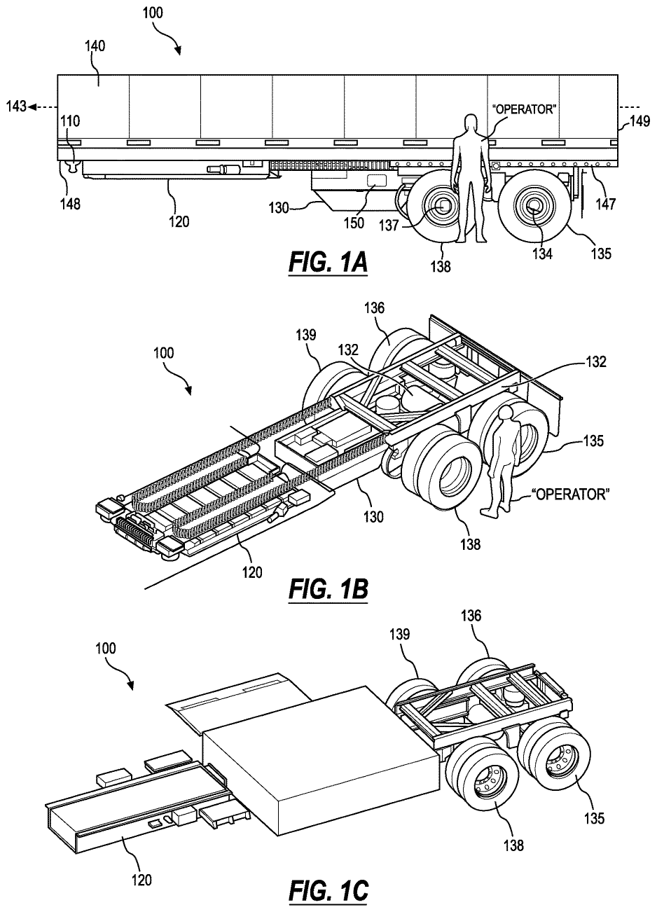

As shown in FIG. 1, a system 100 for tow control of a trailer 140 includes: a bogie 130; a battery assembly 120; and a controller 150. The bogie 130 includes: a bogie chassis 132 configured to transiently install on a left rail 147 and a right rail 147 of the trailer 140 over a range of longitudinal positions; a first set of latches 133 configured to transiently engage a first subset of engagement features 144, in a first array of engagement features 144 on the left rail 147 and in a second array of engagement features 144 on the right rail 147, to retain the bogie 130 below a floor 146 of the trailer 140; a driven axle 137 suspended from the bogie chassis 132; and a motor 131 coupled to the driven axle 137. The battery assembly 120 includes a second set of latches 133 configured to transiently engage a second subset of engagement features 144, in the first array of engagement features 144 on the left rail 147 and in the second array of engagement features 144 on the right rail 147, to retain the first battery assembly 120 below the floor 146 of the trailer 140. The controller 150 is configured to: trigger the first battery assembly 120 to supply electrical energy to the motor 131 to output torque to the driven axle 137 in a tow mode; and trigger the motor 131 to supply electrical energy to the first battery assembly 120 to regeneratively brake the driven axle 137 and charge the first battery assembly 120 in a regenerative braking mode.

In one variation, the system 100 includes: a trailer 140; a bogie 130; and a battery assembly 120. In this variation, the trailer 140 includes: a floor; a left rail 147 coupled to the floor, extending parallel to and laterally offset from a longitudinal centerline of the trailer 140, and defining a first array of engagement features 144 distributed along the left rail 147 and longitudinally offset by a pitch distance; and a right rail 147, coupled to the floor, extending parallel to and laterally offset from the longitudinal centerline of the trailer 140 opposite the left rail 147, and defining a second array of engagement features 144 distributed along the right rail 147 and longitudinally offset by the pitch distance.

In this variation, the bogie 130 further includes: a bogie chassis 132; a first set of latches 133 configured to transiently engage a first subset of engagement features 144, in the first array of engagement features 144 and in the second array of engagement features 144, to retain the bogie 130 below the floor 146 of the trailer 140. a driven axle 137 suspended from the bogie chassis 132; and a motor 131 coupled to the driven axle 137. The battery assembly 120 includes a second set of latches 133 configured to: transiently engage a second subset of engagement features 144, in the first array of engagement features 144 and in the second array of engagement features 144, to retain the battery assembly 120 below the floor 146 of the trailer 140 adjacent the bogie 130; and supply electrical energy to the motor 131.

In another variation, the system 100 includes a bogie 130 and a battery assembly 120. The bogie 130 includes: a bogie chassis 132 configured to transiently install on the trailer 140 over a range of longitudinal positions; a first set of latches 133 configured to transiently engage a first subset of engagement features 144, in a first array of engagement features 144 on a left rail 147 of the trailer 140 and in a second array of engagement features 144 on the right rail 147 of the trailer 140, to retain the bogie 130 below a floor 146 of the trailer 140; a driven axle 137 suspended from the bogie chassis 132; and a motor 131 coupled to the driven axle 137 and configured to output torque to the driven axle 137 and regeneratively brake the driven axle 137. The battery assembly 120: includes a second set of latches 133 configured to transiently engage a second subset of engagement features 144, in the first array of engagement features 144 and in the second array of engagement features 144, to retain the battery assembly 120 below the floor 146 of the trailer 140 adjacent the bogie 130; and is configured to receive electrical energy from the motor 131 to recharge the battery assembly 120.

### 1.1 Variation: Trailer-Mounted Modular Kit

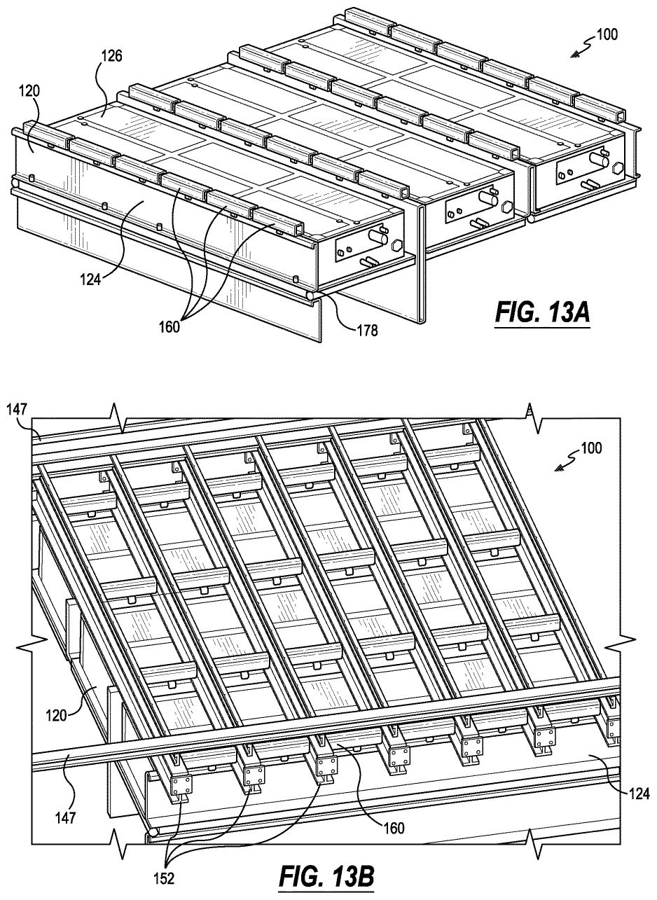

As shown in FIGS. 13A, 13B, 14A, 14B, and 15A-15C, one variation of a system 100 includes a kit including: a driven axle configured to install on a trailer; a motor coupled to the driven axle; and a battery assembly 120 configured to install on the trailer 140.

The battery assembly 120 includes: a set of cross members 124; a set of batteries 126 arranged between the set of cross members 124; a set of clamps 160; and a set of fasteners 164.

Each clamp 160 in the set of clamps 160 is: pivotably coupled to a cross member 124 in the set of cross members 124; and configured to couple the battery assembly 120 to a pair of adjacent beams 152 of the trailer 140 to suspend the battery assembly 120 below the trailer 140.

Each fastener 164 in the set of fasteners 164 is configured to: extend through a cross member 124 in the set of cross members 124; and couple a clamp 160, in the set of clamps 160, to the cross member 124.

### 1.2 Variation: Trailer-Mounted Battery Assembly

As shown in FIGS. 13A, 13B, 14A, 14B, and 15A-15C, one variation of a system 100 includes a battery assembly 120 configured to install under a floor of a trailer 140 and including: a set of cross members 124; a set of batteries 126 arranged between the set of cross members 124; a set of clamps 160; and a set of fasteners 164. Each clamp 160 in the set of clamps 160 is: pivotably coupled to a cross member 124 in the set of cross members 124; and configured to couple the battery assembly 120 to a pair of adjacent beams 152 of the trailer to suspend the battery assembly below the trailer 140. Each fastener 164 in the set of fasteners 164 is configured to couple a clamp 160, in the set of clamps 160, to the cross member 124.

### 1.3 Variation: Single-Fastener Clamp Actuation

As shown in FIGS. 13A, 13B, 14A, 14B, and 15A-15C, one variation of a system 100 includes a battery assembly 120 configured to install on a trailer 140 and including: a set of cross members 124; a set of batteries 126 arranged between the set of cross members 124; a clamp 160; and a fastener 164. The clamp 160 is: pivotably coupled to a cross member 124 in the set of cross members 124; and configured to couple the battery assembly 120 to a pair of adjacent beams 152 of the trailer to suspend the battery assembly below the trailer 140. The fastener 164 is configured to: extend through the cross member 124 and into a nut 162 of the clamp 160; and rotate the nut 162 and the clamp 160 in a plane orthogonal to a longitudinal axis of the fastener 164 to couple the clamp 160 to a pair of adjacent beams 152 of the trailer 140.

### 2. Applications

Generally, the system 100 includes: a bogie 130 that transiently (e.g., temporarily) installs on a floor 146 of a trailer 140 over a range of longitudinal positions over time, includes a driven axle 137 and a motor 131 coupled to the driven axle 137; a battery assembly 120 or a set of modular batteries 120 that enable a user to selectively adjust the battery capacity as a function of a predicted distance traveled by the trailer 140, a weight distribution of the trailer 140, a type of the trailer 140 (e.g., a dry van trailer 140, a refrigerated trailer 140), and/or a length of the trailer 140 (e.g., 20 feet, 40 feet, 48 feet, 53 feet, 60 feet); and a controller 150 configured to trigger the battery assembly 120 to supply electrical energy to the motor 131 to output torque to the driven axle 137 in a tow mode and trigger the motor 131 to supply electrical energy to the battery assembly 120 to regeneratively brake the driven axle 137 and charge the battery assembly 120 in a regenerative braking mode.

In particular, the bogie 130 includes a set of latches 133—such as solenoids, manual latches, pneumatic latches, or other electromechanical latches—configured to transiently engage corresponding engagement features 144 on the left rail 147 and the right rail 147, to retain the bogie 130 below the floor 146 of the trailer 140. Each latch is operable in an engaged position (e.g., a closed position) to engage and retain a corresponding engagement feature to couple the bogie 130 to the floor 146 of the trailer 140 and thereby prevent unauthorized access and/or removal of the bogie 130 from the trailer 140. Further, each latch is operable in a disengaged position (e.g., an open position) to disengage from a corresponding engagement feature and decouple the bogie 130 from the floor 146 of the trailer 140 and thereby enable a user to manually adjust the position of the bogie 130 or remove and service the bogie 130 (e.g., clean the bogie 130, replace the motor 131, clean the driven wheels) without additional tools.

Additionally, the system 100 is configured to dynamically tow and regeneratively brake a trailer 140 (e.g., a towed vehicle) by: selectively entering an operational mode (e.g., a tow mode, a regenerative braking mode, a service mode); selectively operating the motor 131 of the bogie 130 in a tow mode to output torque to the driven axle 137; detecting a direction of motion of the trailer 140; accessing signals output by sensors coupled to an emergency brake line (e.g., a supply brake line, a spring-brake relay), suspension systems, and wheels of the trailer 140; identifying errors (e.g., sensor failure, pneumatic or mechanical brake failure of the trailer 140); interpreting air pressures and a load distribution on the driven axle 137 via these sensors; leveraging these air pressures and load distribution to automatically transition from the tow mode to the regenerative braking mode and vice versa; and, in a regenerative braking mode, trigger the motor 131 to selectively increase or decrease the supply of an electrical energy flux to the battery assembly 120 to regeneratively brake the driven axle 137 and charge the battery assembly 120 based on these signals and identified errors.

### 2.1 Tow Mode

In tow mode, the controller 150 can detect conditions of the trailer 140 such as: a direction of motion of the trailer 140 (e.g., a forward direction, a reverse direction); a tractor-trailer (e.g., a steering angle); a speed of the trailer 140; an incline angle of the trailer 140 (e.g., a grade of a ground surface); a location of the trailer 140; forces applied to the kingpin 110 (e.g., lateral forces, longitudinal forces, vertical forces, total forces); and/or a charge state of each battery assembly 120 coupled to the trailer 140 (e.g., a status, a level, a percentage). The controller 150 can then: calculate a target preload force proportional to and/or inversely proportional to the condition of the trailer 140; and trigger the battery assembly 120 to supply electrical energy to the motor 131 to increase torque output and/or reduce torque output to the driven axle 137 in the direction of motion of the trailer 140 to decrease a difference between the target preload force and a total force applied to the kingpin (e.g., an actual force) to control the trailer 140 in conjunction with the tow vehicle.

### 2.2 Regenerative Braking Mode

The controller 150 can access signals output by a pressure sensor 115 coupled to a spring-brake relay of a tow vehicle to automatically transition from the tow mode to the regenerative braking mode and vice versa.

Furthermore, the controller 150 can access air signals received from the tow vehicle via the gladhand, the target preload force, and signals output from a set of wheel speed sensors to automatically apply a proportion of braking force to the driven axle 137 from the pneumatic or mechanical brake system of the trailer 140 and/or regeneratively brake the driven axle 137, and thereby maintain traction between the driven wheels of the trailer 140 and a ground surface.

Therefore, the controller 150 can trigger the motor 131 to apply the dynamic target preload force, torque output, and regenerative braking: to prevent a jackknife event between the tow vehicle and the trailer 140 (e.g., tow vehicle brakes to a stop and the trailer 140 continues to move toward and push the tow vehicle or torque applied to the kingpin); to prevent wheel lockup of the trailer 140; to maintain traction between the driven wheels of the trailer 140 and a ground surface; to reduce emissions by the tow vehicle; to decrease fuel consumption by the tow vehicle; to extend the life of each battery assembly 120 coupled to the trailer 140; and to enable a driver of the tow vehicle to apply minimal to no brake force to the trailer 140.

### 2.3 Example Configurations

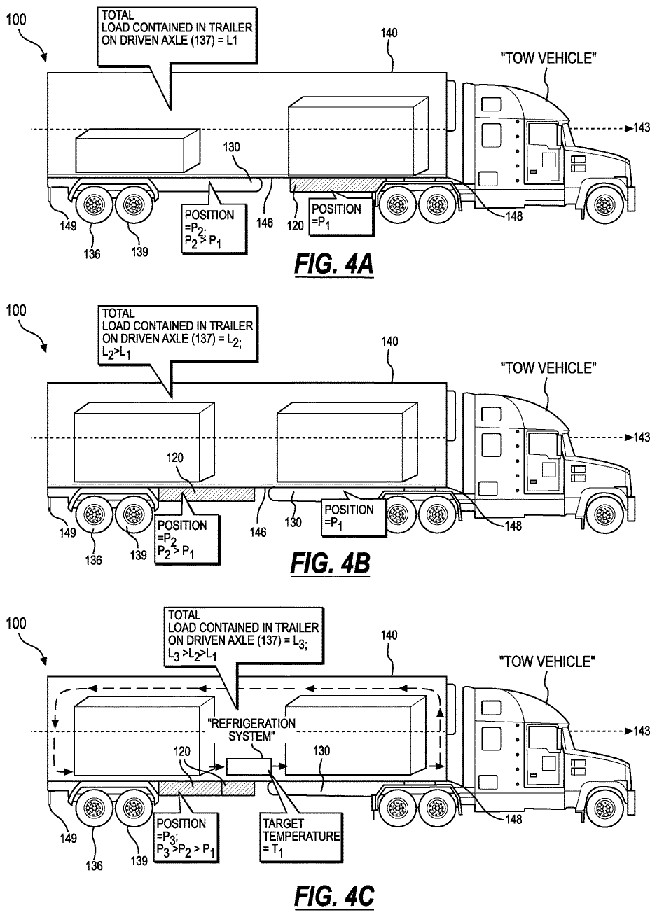

Generally, a trailer 140 includes a left rail 147 and a right rail 147 that couple to a floor 146 of the trailer 140. The left rail 147 and the right rail 147 run along a longitudinal axis 143 of the trailer 140, extending parallel to and laterally offset from a longitudinal centerline, such that when coupled to a bogie 130, a user (e.g., an operator, a driver, a technician) or a machine may manipulate the bogie 130 along the left rail 147 and the right rail 147 to a target position (e.g., a longitudinal position) below the floor 146 of the trailer 140 and thus, transiently install the bogie 130 below the floor 146 of the trailer 140 over a range of longitudinal positions. More specifically, the user or machine may manipulate the bogie 130 and a battery assembly 120, electrically coupled to the bogie 130, along the left rail 147 and the right rail 147 to a target position as a function of weight distribution (e.g., a payload) of the trailer 140, as shown in FIGS. 4A, 4B, and 4C.

For example, an operator may install the bogie 130 and the battery assembly 120 to target positions to support (e.g., balance) a weight distribution of the trailer 140 on the driven axle 137. In this example, the user may install the battery assembly 120 on the left rail 147 and the right rail 147 (e.g., via latches 133) and arrange the battery assembly 120 in a first position on a proximal end of the trailer 140 (e.g., facing a hitch of a tow vehicle). Then, the user may install the bogie 130 on the left rail 147 and the right rail 147 (e.g., via latches 133) and manipulate the bogie 130 along the longitudinal axis 143 of the trailer 140 to arrange the bogie 130 in an opposite position on the distal end of the trailer 140 within a threshold distance of the battery assembly 120 to balance a weight of the trailer 140, containing a first load, on the driven axle 137.

Alternatively, in this example, the user may install the bogie 130 on the left rail 147 and the right rail 147 (e.g., via latches 133) and manipulate the bogie 130 along the longitudinal axis 143 of the trailer 140 to arrange the bogie 130 in a first position on the proximal end of the trailer 140 (e.g., facing a hitch of a tow vehicle). Then, the user may install the battery assembly 120 on the left rail 147 and the right rail 147 (e.g., via latches 133) and manipulate the bogie 130 along the longitudinal axis 143 of the trailer 140 to arrange the battery assembly 120 in an opposite position on the distal end of the trailer 140 within a threshold distance of the bogie 130 to balance a weight of the trailer 140, containing a load different from the first load, on the driven axle 137.

### 2.4 Modular Kit and Retrofit Installation of Batteries

In one application, the system 100 can include a modular kit 180 including: a battery assembly 120 configured to transiently install below a floor 146 of an existing trailer 140; a set of cross members 124 coupled to the battery assembly 120; a set of clamps 160 pivotably coupled to the set of cross members 124; and a set of fasteners 164 configured to couple each clamp 160 to a corresponding cross member 124. The modular kit 180 can further include a driven axle 137 configured to install on the trailer 140 and a motor 131 coupled to the driven axle 137. Generally, the modular kit 180 can install on an existing trailer 140 to suspend the battery assembly 120 below the floor 146 of the trailer 140 without drilling, welding, or other irreversible modification of the trailer 140.

In particular, the trailer 140 can include a set of beams 152 (e.g., I-beams), arranged below the floor 146 of the trailer 140, configured to support the floor 146 and loads carried by the trailer 140. More specifically, these beams 152 are primarily configured to support floor loads of the trailer 140 (e.g., palletized cargo, forklift loads) rather than to support accessories suspended below the trailer 140. Additionally, a pitch distance between adjacent beams 152 and a cross-sectional flange geometry of each beam 152 can vary between trailer manufacturers, between trailer types (e.g., a dry van trailer, a refrigerated trailer), and between trailer lengths (e.g., 38 feet, 48 feet, 53 feet).

More specifically, drilling or welding a custom bracket to the beam 152 may render installation of the battery assembly 120 irreversible and may prevent recovery and/or redeployment of the battery assembly 120 when the trailer 140 is retired from service. In one example, to install an accessory (e.g., a diesel fuel tank, a lift gate battery) below the floor 146 of the trailer 140, an operator may drill a set of holes through the web of a beam 152 and install the accessory via a set of custom brackets fastened to the beam 152 through the set of holes. However, the set of holes may permanently weaken the beam 152 and support only a bracket geometry specific to the accessory and the beam geometry. Additionally, when installing a set of battery assemblies 120 (e.g., exhibiting a combined weight between 3,000 pounds and 6,000 pounds), the load concentrated at the set of holes may fatigue the beam 152 and degrade the structural integrity of the trailer 140.

Accordingly, the modular kit 180 can include: a set of clamps 160 pivotably coupled to a set of cross members 124 of the battery assembly 120 and configured to engage a lower flange 156 of each beam 152 in a pair of adjacent beams 152 of the trailer 140 without drilling, welding, or otherwise permanently modifying the beams 152; and a set of fasteners 164, each fastener 164 configured to rotate a corresponding clamp 160 into an engaged position and draw the clamp 160 toward a corresponding cross member 124 to pinch the lower flange 156 between the clamp 160 and the cross member 124, thereby coupling the battery assembly 120 to the trailer 140.

More specifically, each clamp 160 can transition between an engaged position and a disengaged position responsive to rotation of a corresponding fastener 164 in the set of fasteners 164. In the disengaged position, each clamp 160 is oriented parallel to the pair of adjacent beams 152 and can pass vertically through a gap defined between a pair of adjacent beams 152 of the trailer 140. In the engaged position, each clamp 160 is oriented perpendicular (i.e., orthogonal) to the pair of adjacent beams 152 and pinches a lower flange 156 of each beam 152 in the pair of adjacent beams 152 between the clamp 160 and a corresponding cross member 124 to suspend the battery assembly 120 from the beams 152. Therefore, an operator can install or remove the battery assembly 120 from the trailer 140 with a single tool (e.g., an impact driver with a socket extension) and without accessing the top surface of the floor 146 of the trailer 140.

Therefore, an operator (e.g., an installer, a fleet technician) can retrofit the battery assembly 120 onto the trailer 140 with a single tool (e.g., an impact driver), at a customer location (e.g., a gravel yard), and without specialized facilities. Furthermore, the operator can reverse the installation by rotating each fastener 164 in an opposite direction to release the corresponding clamp 160 from the lower flange 156 of each beam 152, and thereby recover the battery assembly 120 from the trailer 140 for redeployment on a different trailer 140, for service, or for replacement.

### 2.5 Variation: Modular Accessory Mounting

Generally, the modular kit 180 can include a set of clamps 160 configured to couple a battery assembly 120 to a pair of adjacent beams 152 of the trailer 140 to suspend the battery assembly 120 below the floor 146 of the trailer 140. The set of clamps 160 are configured to install on various types of existing trailers (e.g., a dry van trailer, a refrigerated trailer) with minimal or no disassembly of or irreversible modification to the existing trailer 140.

Additionally or alternatively, the modular kit 180 can include a set of clamps 160 configured to couple an accessory (e.g., an auxiliary fuel tank, a tool storage box, a sensor module, a power electronics module) to a pair of adjacent beams 152 of the trailer 140 to suspend the accessory below the floor 146 of the trailer 140.

### 3. Trailer

As shown in FIG. 13B, the trailer 140 includes: a floor 146; a set of rails 147 arranged below the floor 146 and extending along a longitudinal axis 143 of the trailer 140; and a set of beams 152 (e.g., I-beams) arranged below the floor 146 and extending along a lateral axis, orthogonal to the longitudinal axis 143, of the trailer 140.

Each beam 152 (e.g., an aluminum, galvanized steel, or stainless steel beam 152) in the set of beams 152 can include: a pair of upper flanges 154 coupled to the floor 146; a pair of lower flanges 156 opposite the pair of upper flanges 154, each lower flange 156 and a corresponding upper flange 154 defining a channel (e.g., a c-shaped channel) along a side of the beam 152; and a web (i.e., a vertical plate) interposed between the pair of upper flanges 154 and the pair of lower flanges 156. In particular, the set of beams 152 is arranged along the longitudinal axis 143 of the trailer 140 at a pitch distance (e.g., between 10 inches and 12 inches), such that each beam 152 in the set of beams 152 is longitudinally offset from an adjacent beam 152 by the pitch distance. In particular, a pair of adjacent beams 152 includes a first beam 152 and a second beam 152, in the set of beams 152, separated by the pitch distance along the longitudinal axis 143 of the trailer 140. The pair of adjacent beams 152 can define a gap between the lower flange 156 of the first beam 152 and the lower flange 156 of the second beam 152, along the longitudinal axis 143 of the trailer 140.

### 3.1 Engagement Features

In one variation the trailer 140 includes: a floor 146; a left rail 147 coupled to the floor 146, extending parallel to and laterally offset from a longitudinal centerline of the trailer 140, and defining a first array of engagement features 144 distributed along the left rail 147 and longitudinally offset by a pitch distance; and a right rail 147 coupled to the floor 146, extending parallel to and laterally offset from the longitudinal centerline of the trailer 140 opposite the left rail 147, and defining a second array of engagement features 144 distributed along the right rail 147 and longitudinally offset by the pitch distance. In this implementation, the set of rails 147 extend along a length of the trailer 140 and define a channel below the floor 146 of the trailer 140. Alternatively, the set of rails 147 extend along a portion of the length of the trailer 140 and define a channel below the floor 146 of the trailer 140.

Additionally, the left rail 147 and the right rail 147 are configured to run along a longitudinal axis 143 of the trailer 140, parallel to the longitudinal centerline, such that, when coupled to a bogie 130, a user (e.g., an operator, a driver, a technician) or a machine may manipulate the bogie 130 between the left rail 147 and the right rail 147 to guide the bogie 130 to a target position (e.g., a longitudinal position) below the floor 146 of the trailer 140 and/or to remove the bogie 130 from the floor 146 of the trailer 140 in a service mode.

Furthermore, the set of engagement features 144 can include a bore, a slot, an aperture, or an indentation distributed along each rail 147 and configured to engage and retain a corresponding latch of a bogie 130 and/or a battery assembly 120, as further described below. However, each rail 147 can include any other type of engagement feature configured to engage and retain a set of latches 133 of a bogie 130 and/or a battery assembly 120.

### 4. Bogie

Generally, the bogie 130 includes: a bogie chassis 132 configured to transiently install on the trailer 140; a set of latches 133; a driven axle 137 suspended from the bogie chassis 132; and a motor 131 coupled to the driven axle 137. The bogie 130 includes: a driven axle 137 suspended from the bogie chassis 132; and a motor 131 coupled to the driven axle 137 configured to output torque to the driven axle 137 in a tow mode and regeneratively brake the driven axle 137 in a regenerative braking mode. In one example, the bogie 130 can further include: a set of latches 133 configured to transiently engage a subset of engagement features 144 on the left rail 147 and the right rail 147 to retain the bogie 130 below the floor 146 of the trailer 140;

The bogie chassis 132 is configured to transiently install on a trailer 140 over a range of longitudinal positions and supports the driven axle 137. The bogie chassis 132 can be manufactured from a metal such as galvanized steel or stainless steel and coupled to the floor 146 of the trailer 140. Additionally, the bogie chassis 132 can be mounted to the floor 146 such as by welding the bogie chassis 132 to the floor 146 of the trailer 140 or bolting the bogie chassis 132 to the floor 146 of the trailer 140 via a set of fasteners.

In one variation, the bogie 130 further includes a secondary battery assembly 122 mounted to the bogie chassis 132 of the bogie 130, and the controller 150 can trigger the secondary battery assembly 122 to supply electrical energy to the motor 131 to assist motion of the bogie 130 away from the trailer 140 in a service mode.

In another variation, the bogie 130 includes a suspension system, such as a leaf suspension system, a rubber block suspension system, or an air-ride suspension system coupled to the driven axle 137. For example, the bogie 130 can include an air-ride suspension system that includes: a first air bag arranged proximal a left driven wheel 138 of the driven axle 137; and a second air bag arranged proximal a right driven wheel 139 of the driven axle 137. The bogie 130 can further include a pressure sensor 115 coupled to the driven axle 137 and configured to output a signal representing a combined air pressure in the first air bag and the second air bag. In this variation, the controller 150 is configured to leverage the air-ride suspension system and the pressure sensor 115 to monitor air pressure in the first and second air bags and calculate a weight of the trailer 140, containing a load, on the driven axle 137 based on the air pressure in the first and second air bags.

In yet another variation, the bogie 130 includes a compressed-air-brake system configured to couple to a gladhand of a brake line from a tow vehicle coupled to the trailer 140 and brake the driven axle 137 responsive to air signals received from the tow vehicle via the gladhand. For example, a user (e.g., a technician, an operator) may manually couple a supply line (e.g., an emergency brake line) and a control line (e.g., a service brake line) of the trailer 140 to a compressed air supply line of a tow vehicle via a set of hose couplings (e.g., a gladhand coupler, a gladhand connector). The user may then couple a compressed-air-brake system of the bogie 130 to the gladhand coupling between the tractor and the trailer 140. The controller 150 can then leverage the compressed air signal from the tow vehicle via the gladhand to selectively brake the driven axle 137 via the pneumatic or mechanical brake system of the trailer 140 and/or enter a regenerative braking mode and alternate the proportion of braking from the pneumatic or mechanical brake system of the trailer 140 and from regenerative braking.

Further, the system 100 can include a set of wheel speed sensors, each wheel speed sensor can couple to a corresponding driven wheel of the bogie 130. The controller 150 can then leverage signals output from each wheel speed sensor to track traction between the driven wheels of the bogie 130 and a ground surface and trigger the motor 131 to regeneratively brake the trailer 140, as further described below.

However, the bogie chassis 132 can be manufactured in any other way and transiently installed on the trailer 140 in any other way.

### 4.1 Latches

Generally, the set of latches 133 is configured to cooperate with the array of engagement features 144 distributed along the left rail 147 and the right rail 147 to retain the bogie 130 below the floor 146 of the trailer 140 over a range of longitudinal positions.

In one implementation, the set of latches 133 is configured to transiently engage a first subset of engagement features 144, in a first array of engagement features 144 on the left rail 147 and in a second array of engagement features 144 on the right rail 147 of the trailer 140, to retain the bogie 130 below a floor 146 of the trailer 140.

More specifically, in this implementation, each latch in the set of latches 133 can include a solenoid (e.g., an electromechanical solenoid, a pneumatic solenoid), or another electrical or mechanical latch (e.g., an air pressure latch, a mechanical lever) configured to transiently engage with a corresponding engagement feature in the array of engagement features 144 distributed along the left rail 147 and the right rail 147 of the trailer 140. Further, each solenoid or other electromechanical latch can be operable in an engaged position (e.g., a closed position) to engage and retain a corresponding engagement feature to couple the bogie 130 to the floor 146 of the trailer 140. In the engaged position, each solenoid or other latch remains engaged with the corresponding engagement feature to prevent slippage of the bogie 130 away from the trailer 140 while the trailer 140 is in motion. Alternatively, each solenoid or other latch can be operable in a disengaged position (e.g., an open position) to disengage from the corresponding engagement feature and decouple the bogie 130 from the floor 146 of the trailer 140 and thereby enable a user to selectively adjust the position of the bogie 130 and remove or service the bogie 130 (e.g., clean the bogie 130, replace the motor 131, clean the driven wheels) without additional tools.

Additionally, each solenoid or other latch can be actuated by a user input such as a physical key, a manual switch, a manual valve or via wireless communication with a computational device (e.g., a mobile phone, a tablet) of a user (e.g., an operator, a driver, a technician) to engage and disengage each solenoid or other electromechanical latch from the corresponding engagement feature on the left rail 147 and the right rail 147, thereby enabling the user to freely guide the bogie 130 along the left rail 147 and the right rail 147 to a target position and/or to remove the bogie 130 for service (e.g., replacement of the left driven wheel or the right driven wheel, replacement of the motor 131). Thus, the set of latches 133 can cooperate with the engagement features 144 of the left rail 147 and the right rail 147 to prevent unauthorized access and/or removal of the bogie 130 from the trailer 140.

However, the bogie 130 can include any other type of latch or solenoid configured to support the longitudinal load of the bogie 130 in an engaged position and to transiently install the bogie 130 to the trailer 140 over a range of longitudinal positions.

### 4.2 Coupling Mechanism

In one variation, the system 100 can further include a coupling mechanism (e.g., a mechanical clamp, a hydraulic clamp, an electromechanical clamp, a locking pin) configured to engage the bogie 130, on a distal end of the trailer 140, to the floor 146 of the trailer 140. The coupling mechanism is further configured to prevent slippage of the set of rails 147 along a longitudinal axis 143 of the trailer 140 and thus, the bogie 130, once the set of latches 133 is engaged with corresponding engagement features 144.

For example, a user or a machine may: arrange the bogie 130 below the floor 146 of the trailer 140 to align the set of latches 133 with corresponding engagement features 144 on the left rail 147 and the right rail 147 of the trailer 140. Then, the user may manipulate the bogie 130 along the floor 146 of the trailer 140 via the left rail 147 and the right rail 147 to guide the bogie 130 toward a target position and balance a weight distribution of the trailer 140. Once the user confirms the bogie 130 is in the target position and the set of latches 133 is in the engaged position with the left rail 147 and the right rail 147, the user may arrange the coupling mechanism in an engaged position to lock the bogie 130 to the trailer 140 and prevent slippage of the bogie 130 away from the floor 146 of the trailer 140.

Alternatively, once the user confirms the bogie 130 is in the target position and the set of latches 133 is in the engaged position with the left rail 147 and the right rail 147, a controller 150 can trigger an actuator to mechanically actuate the coupling mechanism into an engaged position to lock the bogie 130 to the trailer 140 and prevent slippage of the bogie 130 away from the floor 146 of the trailer 140.

Therefore, the coupling mechanism can cooperate with the set of latches 133 to engage and retain the bogie 130 below the floor 146 of the trailer 140, prevent slippage of the bogie 130 away from the floor 146 of the trailer 140, and prevent unauthorized access and/or removal of the bogie 130 from the trailer 140.

### 4.3 Drag Chain

In one variation, as shown in FIG. 1B, the system 100 can further include a drag chain: coupled to the trailer chassis; arranged proximal the set of rails 147 of the trailer 140; and configured to permit a user to selectively adjust the longitudinal position of the bogie 130 without additional tools. The drag chain includes: an actuator rider guard (e.g., a chain cable carrier) configured to house a set of electrical cables (e.g., power cables); and a set of mechanical hanging brackets configured to couple to the battery assembly 120. The actuator rider guard is arranged along the longitudinal axis of the trailer 140, configured to house a set of power cables (e.g., a high-voltage power chain, a low-voltage power chain, an anti-lock braking system connection cable), and includes a distal end coupled to the bogie 130.

Additionally, the battery assembly 120 is arranged proximal the bogie 130 and coupled to the bogie 130 via a set of fasteners. In one example, the drag chain is arranged within a channel of the battery assembly 120 and coupled to the battery assembly 120 via the set of hanging brackets. Therefore, the user may selectively adjust the longitudinal position of the bogie 130 below the trailer chassis without additional tools.

For example, the actuator rider guard is configured to house a first power cable electrically coupled between the battery assembly 120 and the bogie 130 and a second power cable electrically coupled to the tow vehicle. The user may then manually disengage the set of latches of the bogie 130 from corresponding engagement features 144 along the set of rails 147 and selectively adjust the bogie 130, the battery assembly 120, and the drag chain along the set of rails 147 to a target position and thus, guide the first and second power cables within the actuator rider guard. Therefore, a user may freely guide the bogie 130 over a range of longitudinal positions and prevent damage or collision to the power cables in the system 100.

### 4.4 Driven Axle+Motor

In one implementation, the driven axle 137 is supported by an axle housing, suspended from the bogie chassis 132, and includes a left driven wheel 138 and a right driven wheel 139. The axle housing further encapsulates a motor 131 mounted to the driven axle 137 and is configured to protect the driven axle 137 and the motor 131 when the bogie 130 is adjusted along the floor 146 of the trailer 140 and/or removed for service. In this implementation, the motor 131 is configured to drive the left driven wheel 138 and the right driven wheel 139 and thus, output torque in a tow mode. The motor 131 is further configured to regeneratively brake the left driven wheel 138 and the right driven wheel 139 to slow motion of the trailer 140 in a regenerative braking mode.

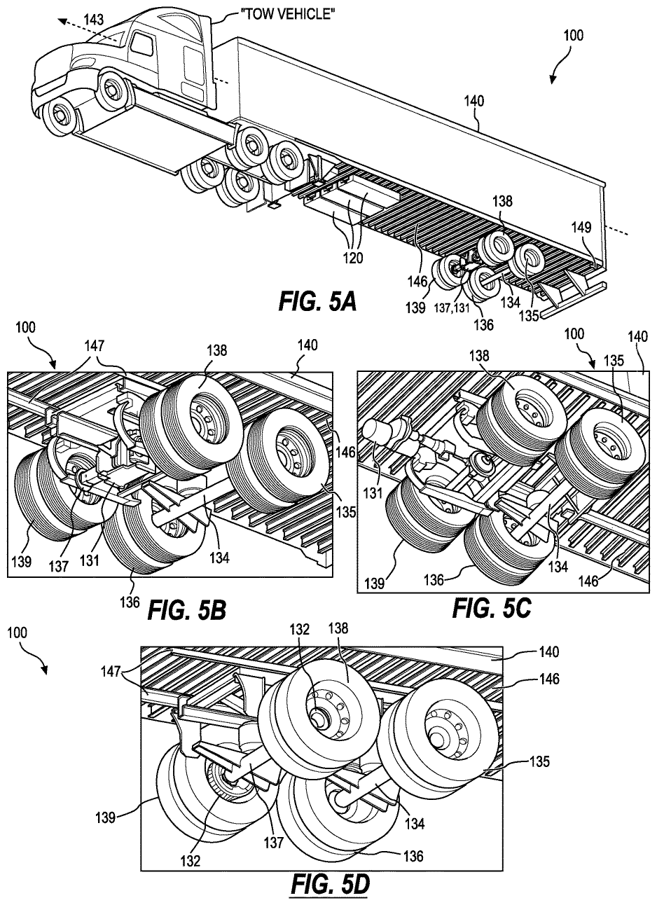

In one variation, shown in FIG. 5A, the bogie 130 includes a passive axle 134, suspended from the bogie chassis 132, adjacent the driven axle 137 and includes a left passive wheel 135 and a right passive wheel 136. In this variation, the left passive wheel 135 and the right passive wheel 136 are configured to assist motion of a trailer 140 when the left driven wheel 138 and the right driven wheel 139 are driven by the motor 131 in the tow mode.

For example, the bogie 130 can include: a bogie chassis 132; a passive axle suspended from the bogie chassis 132 and including a left passive wheel 135 and a right passive wheel 136; a driven axle 137, adjacent the passive axle, suspended from the bogie chassis 132 and including a left driven wheel 138 and a right driven wheel 139; and a motor 131 coupled to the driven axle 137. In this example, the controller 150 can trigger the motor 131 to output torque to the driven axle 137 to drive the left driven wheel 138 and the right driven wheel 139 and thus, the left passive wheel 135 and the right passive wheel 136 in the tow mode. Alternatively, the controller 150 can trigger the motor 131 to regeneratively brake the left driven wheel 138 and the right driven wheel 139 to slow motion of the trailer 140, and thus the left passive wheel 135 and the right passive wheel 136 in a regenerative braking mode.

In another variation, the bogie 130 can include a set of (e.g., two) driven axles 137 and a passive axle (e.g., a tri-axle). Each driven axle 137 is supported by an axle housing, is suspended from the bogie chassis 132, and includes a left driven wheel 138 and a right driven wheel 139. In this variation, each driven axle 137 is suspended from the bogie chassis 132 on a distal end of a trailer 140. Further, the left passive wheel 135 and the right passive wheel 136 are configured to assist motion of the trailer 140 when the left driven wheel 138 and the right driven wheel 139 of each driven axle 137 are driven by the motor 131 in the tow mode.

In yet another variation, the bogie 130 can include a set of (e.g., two) driven axles 137 and a set of (e.g., two) passive axles (e.g., a quad-axle). Each driven axle 137 is supported by an axle housing, is suspended from the bogie chassis 132, and includes a left driven wheel 138 and a right driven wheel 139. Each passive axle is suspended from the bogie chassis 132, arranged adjacent the set of driven axles 137, and includes a left passive wheel 135 and a right passive wheel 136. In this variation, each left passive wheel 135 and right passive wheel 136 are configured to balance a weight of the trailer 140 in conjunction with the left driven wheel 138 and the right driven wheel 139 of each driven axle 137.

### 4.5 Pressure Sensors

The system 100 can further include a set of pressure sensors 115 configured to output signals corresponding to air pressure in brake lines of the trailer 140. Each pressure sensor 115 can then transmit these signals to the controller 150.

In one variation, the system 100 can include a pressure sensor 115 configured to output signals corresponding to air pressure of an emergency brake line (e.g., a supply brake line) system of the trailer 140 from an air supply of the tow vehicle and transmit these signals to the controller 150.

In another variation, the system 100 can include a pressure sensor 115 coupled to the driven axle 137 and configured to output signals corresponding to air pressure of air bags in an air-ride suspension system coupled to the driven axle 137 and transmit these signals to the controller 150.

In yet another variation, the system 100 can include a pressure sensor 115 configured to couple to a spring-brake relay and output signals corresponding to air pressures at the spring-brake relay of the trailer 140 from an air supply of the tow vehicle and transmit these signals to the controller 150.

### 4.6 Kingpin

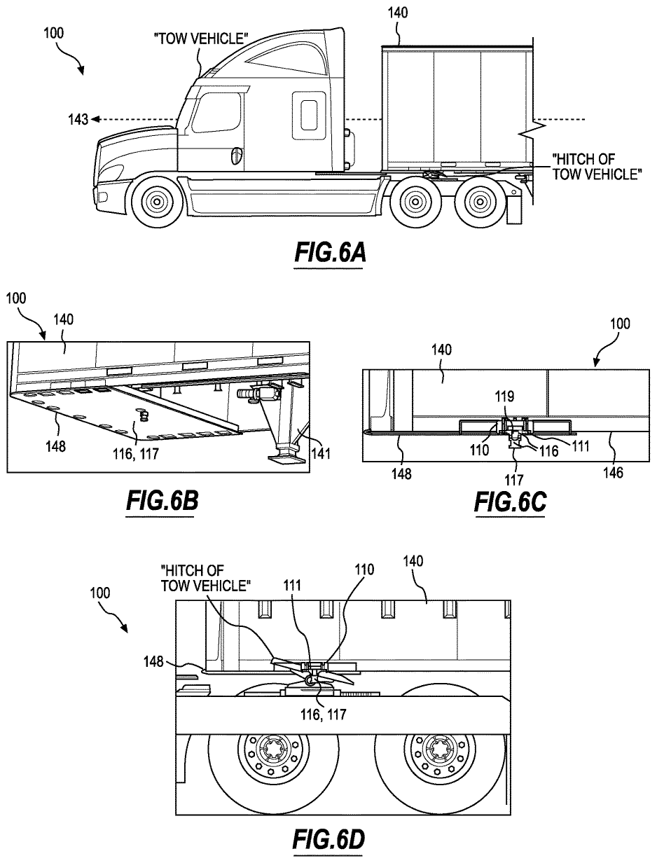

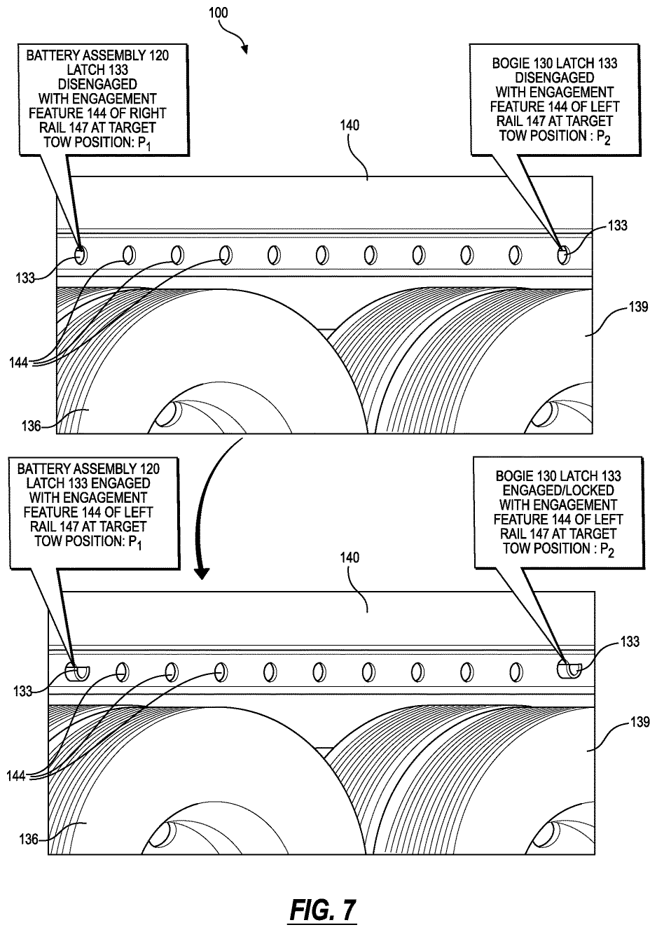

The system 100 further includes a kingpin 110 arranged on a proximal end of the trailer 140 opposite the bogie 130 and is configured to interface with a hitch (e.g., a fifth wheel) of a tow vehicle (e.g., a tractor-trailer 140, a semitruck, a semi). The kingpin 110 further includes a set of sensors configured to output a signal representing forces applied to the kingpin 110 by the hitch, as shown in FIGS. 6A, 6B, 6C, and 6D.

In one implementation, the kingpin 110 includes: a head 117; a shank 116; a base 111; a set of fasteners; a geolocation module; a wireless communications module; and a suite of sensors 119 including force sensors (e.g., a strain gauge, an IMU, a load cell), optical sensors (e.g., a one-dimensional depth sensor, a LIDAR sensor, an RGB camera), and/or inertial sensors (e.g., an IMU, an accelerometer, a gyroscope). The kingpin 110 is further characterized by a unitary steel alloy structure.

In one variation, the kingpin 110 is coupled to a floor 146 of a trailer 140 and is configured to transfer vertical loads from the trailer 140 into a hitch of a tow vehicle. In this variation, the set of sensors 119 are configured to: output signals representing forces applied to the kingpin 110 (e.g., via the force sensors); output signals representing inertial conditions of the trailer 140 (e.g., via the inertial sensors); output signals representing a location of the trailer 140 (e.g., via the geolocation module); and transmit these force data, inertial conditions data, weight distribution data, and/or geolocation data to the integrated controller via the communications module.

### 4.7 Base+Shank+Force Sensors

In another variation, the base 111 of the kingpin 110 defines a set of through-bores 114 arranged radially about the shank 116 and configured to receive a set of fasteners to couple the kingpin to a floor 146 of the trailer 140 and thus, fasten (e.g., mount, fastener 164-in) the kingpin 110 to the trailer 140. In this variation, the shank 116 of the kingpin 110 defines a first sensor receptacle extending parallel to a lateral axis of the trailer 140; and defines a second sensor receptacle extending parallel to a longitudinal axis 143 of the trailer 140. Further, a first strain gauge is arranged in the first sensor receptacle and is configured to output a signal representing shear forces in the kingpin parallel to the lateral axis and a second strain gauge is arranged in the second sensor receptacle and configured to output the second signal representing shear forces in the kingpin parallel to the longitudinal axis 143.

In another variation, the kingpin 110 can include a set of force sensors 119. In this variation, the kingpin 110 can include: a first sensor 119 configured to output signals representing lateral forces (e.g., loads) applied to the kingpin 110; and a second sensor 119 configured to output signals corresponding to longitudinal forces (e.g., loads), parallel to a longitudinal axis 143 of the trailer 140, applied to the kingpin 110. Each sensor can then transmit these force data to the integrated controller.

### 4.8 Variation: Individual Motor+Dual Motors

In one variation, shown in FIGS. 5A, 5B, and 5C, the motor 131 is coupled to the driven axle 137 parallel to the longitudinal centerline of the trailer 140. The controller 150 can then: detect a forward motion of the trailer 140 (e.g., via an IMU coupled to the trailer 140 of kingpin); in tow mode, trigger the battery assembly 120 to supply an electrical energy flux to the motor 131 to output torque to the left driven wheel 138 and the right driven wheel 139 in the forward direction of motion; and, in regenerative braking mode, trigger the motor 131 to supply the electrical energy flux to the battery assembly 120 to regeneratively brake the left driven wheel 138 and the right driven wheel 139 in a reverse direction of motion (e.g., opposite the forward direction of motion) to slow motion of the trailer 140.

In another variation, shown in FIG. 5D, the bogie 130 can include a set of motors coupled to the driven axle 137 and each motor in the set of motors is configured to output torque to a corresponding driven wheel to drive the driven wheel in the direction of motion of the trailer 140 in a tow mode and to regeneratively brake the driven wheel in a regenerative braking mode.

For example, the bogie 130 can include: a left motor coupled to a left side of the driven axle 137 and laterally offset from the longitudinal centerline of the trailer 140; and a right motor coupled to a right side of the driven axle 137 and laterally offset from the longitudinal centerline of the trailer 140 opposite the left motor. The controller 150 can then detect a forward direction of motion of the trailer 140 and in tow mode: trigger the battery assembly 120 to supply a first electrical energy flux to the left motor to output torque to the left driven wheel in the forward direction of motion; and trigger the battery assembly 120 to supply the first electrical energy flux to the right motor 131 to output torque to the right driven wheel in the forward direction of motion. In regenerative braking mode, the controller 150 can: trigger the left motor to supply a second electrical energy flux, different from the first electrical energy flux, to the battery assembly 120 to regeneratively brake the left driven wheel in a reverse direction of motion; and trigger the right motor to supply the second electrical energy flux to the battery assembly 120 to regeneratively brake the right driven wheel in the reverse direction of motion.

Therefore, the controller 150 can trigger an individual motor 131 or a set of motors coupled to the driven axle 137 to output torque to the driven axle 137 or regeneratively brake the driven axle 137, and thus, manipulate the driven wheels of the trailer 140 in a tow mode and in a regenerative braking mode.

### 5. Controller

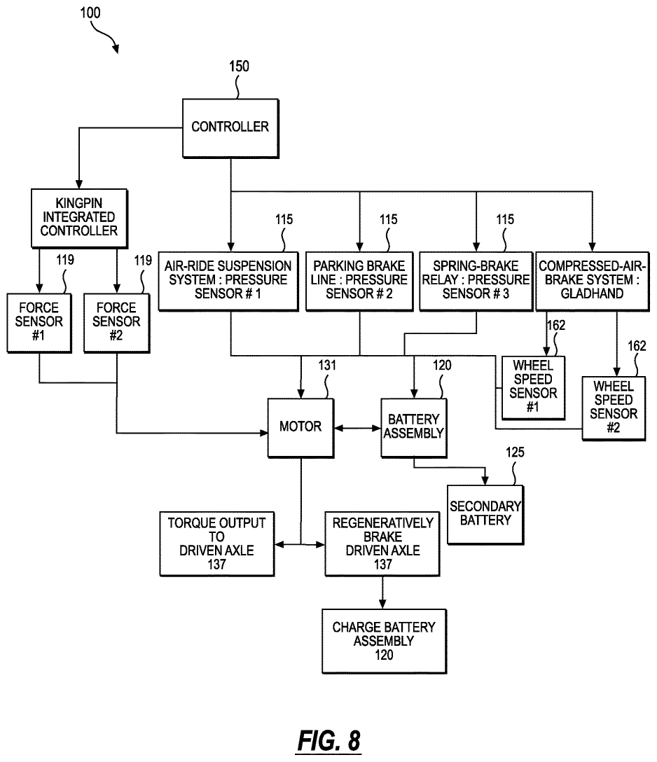

The controller 150 is coupled to sensors within the system 100, interfaces with the integrated controller of the kingpin 110 and executes methods and techniques described below to: selectively enter an operational mode (e.g., a tow mode, a regenerative braking mode, a service mode); in a tow mode, selectively operate the motor 131 of the bogie 130 to output torque to the driven axle 137; detect a direction of motion of the trailer 140; access signals output by sensors coupled to an emergency brake line (e.g., a supply brake line, a spring-brake relay), suspension systems, and wheels of the trailer 140; identify errors (e.g., sensor failure, pneumatic or mechanical brake failure of the trailer 140); and, in a regenerative braking mode, trigger the motor 131 to selectively increase or decrease the supply of an electrical energy flux to the battery assembly 120 to regeneratively brake the driven axle 137 and charge the battery assembly 120 based on these signals and identified errors, as shown in FIG. 8.

### 5.1 Integrated Local Controllers

In one variation, the system 100 includes a primary controller 150 and a set of local controllers. In particular, the bogie 130 can include an integrated local controller configured to interface (e.g., via wireless communication, via wired communication) with the primary controller 150: to selectively operate the motor 131 to output torque to the driven axle 137; to trigger the motor 131 to selectively increase or decrease the supply of an electrical energy flux to the battery assembly 120 to regeneratively brake the driven axle 137; and to trigger the motor 131 to selectively reduce torque output and/or increase torque output to decrease a difference between each force and the target preload force. The battery assembly 120 can include an integrated local controller configured to interface with the primary controller 150 to receive an electrical energy flux from the motor 131 to charge the battery assembly 120.

The kingpin 110 can further include an integrated local controller configured to interface with the primary controller 150 to: calculate a direction and a magnitude of each force applied to the kingpin 110; identify a coupling and/or a decoupling event between a hitch (e.g., a fifth wheel) of a tow vehicle (e.g., a tractor-trailer) and the kingpin 110 based on these forces; and calculate a target preload force as a function of a condition of the trailer 140 (e.g., a speed, an incline angle, a tractor-trailer angle, a location, a charge state of a battery, a weight distribution) in a tow mode.

### 6. Battery Assembly

Generally, the battery assembly 120 is configured to: transiently install on the trailer 140; and electrically couple to the bogie 130 by a power cable (or integrated directly with the bogie chassis 132 of the bogie 130) to supply power to the motor 131. In particular, the battery assembly 120 can supply electrical energy to the motor 131 to output torque to the driven axle 137 in a tow mode and receive electrical energy from the motor 131 to charge the battery assembly 120 in a regenerative braking mode.

As shown in FIGS. 13A and 13B, the battery assembly 120 can include: a battery frame (e.g., a stressed frame); and a set of batteries 126 arranged within the battery frame. The battery frame can include: a base; and a pair of cross members 124 extending from the base. Each cross member 124 can include: an upper surface proximal the set of beams 152 of the trailer 140; a lower surface opposite the upper surface; an inner sidewall proximal the set of batteries 126, extending between the upper surface and the lower surface; and an outer sidewall, opposite the inner sidewall, extending between the upper surface and the lower surface. In particular, the set of batteries 126 can be arranged above the base and between the set of cross members 124 (i.e., proximal inner sidewalls of the cross members 124).

In one implementation, the system 100 can include a set of (i.e., two or more) battery assemblies 120 configured to install on the trailer 140. In particular, the cross members 124 of adjacent battery assemblies 120 can be arranged proximal one another below the floor 146 of the trailer 140. More specifically, a cross member 124 of a first battery assembly 120, in the set of battery assemblies 120, and a cross member 124 of a second battery assembly 120, in the set of battery assemblies 120, can be arranged on opposite sides of a shared beam 152 of the trailer 140.

Additionally, the set of battery assemblies 120 can be selectively configured over time (e.g., battery assemblies 120 can be added or removed from the trailer 140) to adjust total energy storage capacity. For example, an operator may selectively adjust the total energy storage capacity of the battery assembly 120 based on a predicted distance traveled by the trailer 140, a weight distribution of the trailer 140, a type of the trailer 140 (e.g., a dry van trailer 140, a refrigerated trailer 140), and/or a length of the trailer 140 (e.g., 20 feet, 40 feet, 48 feet, 53 feet, 60 feet).

### 7. Variation: Clamps

In one variation, the battery assembly 120 can further include a set of clamps 160 configured to couple the battery assembly 120 to a pair of adjacent beams 152 of the trailer 140 to suspend the battery assembly 120 below the floor 146 of the trailer 140. Each clamp 160 can include: a top surface oriented toward the floor 146 of the trailer 140; a bottom surface opposite the top surface; a set of sidewalls extending between the top surface and the bottom surface; a first end (e.g., a right end) configured to contact a first lower flange 156 of a first beam 152 in a pair of adjacent beams 152 while the clamp 160 engages the pair of adjacent beams 152; a second end (e.g., a left end), opposite the first end, configured to contact a second lower flange 156 of a second beam 152 in the pair of adjacent beams 152 while the clamp 160 engages the pair of adjacent beams 152; and a midsection arranged between the first end and the second end, spanning a gap defined between the pair of adjacent beams 152, and configured to receive a fastener 164 in a set of fasteners 164. Each clamp 160 can be pivotably coupled to a cross member 124 in the set of cross members 124 (or to a pair of adjacent cross members 124 of adjacent battery assemblies) proximal an upper surface of the cross member 124 (or upper surfaces of the pair of adjacent cross members 124).

The battery assembly 120 can further include a set of fasteners 164, each fastener 164 in the set of fasteners 164 configured to: extend through a cross member 124 in the set of cross members 124; and couple a clamp 160, in the set of clamps 160, to the cross member 124. In particular, each fastener 164 can engage a nut 162 of a corresponding clamp 160 such that, as the fastener 164 rotates about a longitudinal axis of the fastener 164, friction between the fastener 164 and the nut 162 rotates the clamp 160 in a plane orthogonal to the longitudinal axis of the fastener 164 and advances or retracts the clamp 160 along the longitudinal axis of the fastener 164 relative to the cross member 124, as described below.

In one example, the system 100 can include: a first battery assembly 120; a second battery assembly arranged proximal the first battery assembly 120; and a set of clamps 160 configured to cooperate to couple the first battery assembly and the second battery assembly 120 to the trailer 140. In particular, the first battery assembly 120 can include: a first cross member 124; and a second cross member 124, opposite the first cross member 124, proximal the second battery assembly 120. The second battery assembly 120 can include: a third cross member 124 proximal the first battery assembly (i.e., adjacent the second cross member 124); and a fourth cross member 124 opposite the third cross member 124. In this example, the set of clamps 160 can include: a first clamp 160 pivotably coupled to the first cross member 124; a second clamp 160 pivotably coupled to the second cross member 124 and the third cross member 124; and a third clamp 160 pivotably coupled to the fourth cross member 124. In particular, the second clamp 160 is pivotably coupled to the second cross member 124 and the third cross member 124, thereby reducing the quantity of clamps 160 required to suspend the first battery assembly and the second battery assembly below the floor 146 of the trailer 140.

In one variation, each clamp 160 in the set of clamps 160 can be formed from a metallic material (e.g., carbon steel, galvanized steel, stainless steel) and can exhibit a clamp 160 length (e.g., between 8 inches and 14 inches) exceeding a pitch distance between adjacent beams 152 of the trailer 140 such that the first end and the second end of the clamp 160 overlap the lower flanges 156 of a first beam 152 and a second beam 152, respectively, in the pair of adjacent beams 152 while the clamp 160 occupies the engaged position.

### 7.1 Clamp Installation and Removal

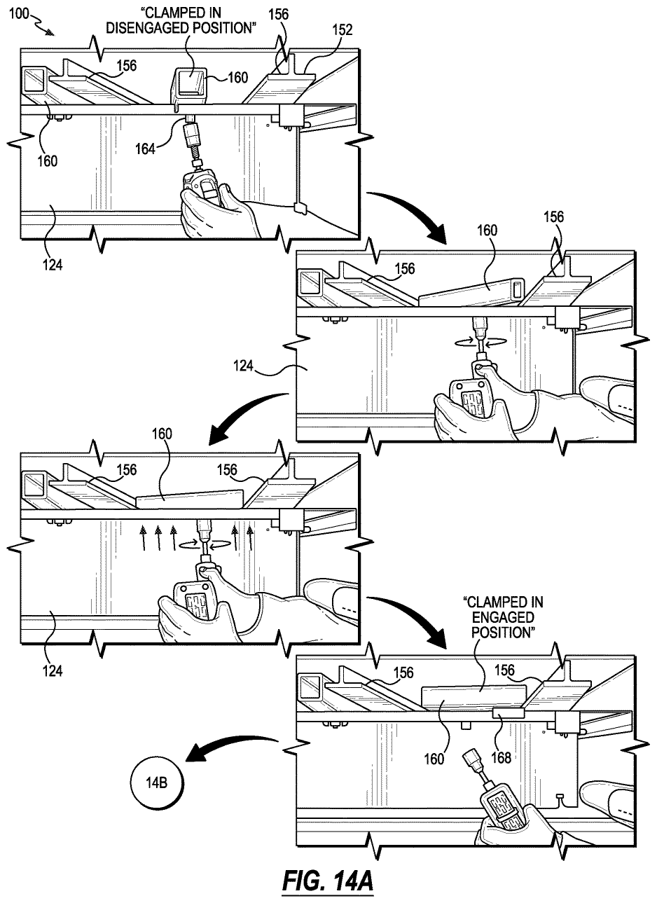

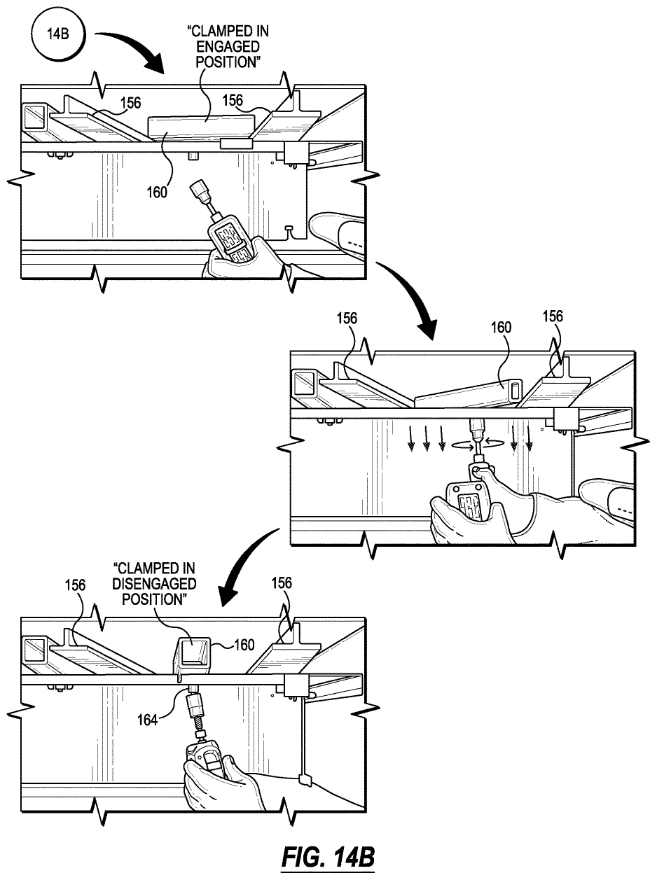

In one implementation, as shown in FIGS. 14A and 14B, each clamp 160 can be operable in: an engaged position to pinch the lower flange 156 of each beam 152 in a pair of adjacent beams 152 between the clamp 160 and the upper surface of the cross member 124, thereby coupling the battery assembly 120 to the pair of adjacent beams 152; and in a disengaged position to release the lower flange 156 of each beam 152 in the pair of adjacent beams 152, thereby decoupling the battery assembly 120 from the pair of adjacent beams 152. In particular, in the disengaged position, the clamp 160 can: be oriented parallel to the pair of adjacent beams 152 of the trailer 140 such that the clamp 160 can pass through the gap defined between the pair of adjacent beams 152; and be retracted from the upper surface of the cross member 124 such that the lower flange 156 of each beam 152 is released from between the clamp 160 and the upper surface of the cross member 124. Conversely, in the engaged position, the clamp 160 can: be oriented orthogonal to the pair of adjacent beams 152 (i.e., in the engaged position); and pinch the lower flange 156 of each beam 152 in the pair of adjacent beams 152 between the bottom surface of the clamp 160 and the upper surface of the cross member 124 to couple the battery assembly 120 to the pair of adjacent beams 152.

In one implementation, each cross member 124 defines an aperture extending through the cross member 124 and configured to receive a fastener 164. Additionally, each clamp 160 can include a nut 162 configured to align with an aperture of a corresponding cross member 124 such that the fastener 164 can extend vertically through the aperture and engage the nut 162. The fastener 164 can then rotate the nut 162 and the clamp 160 in a plane orthogonal to a longitudinal axis of the fastener 164 to couple the clamp 160 to a pair of adjacent beams 152 without manual positioning of the clamp 160. In particular, each fastener 164 in the set of fasteners 164 can be configured to rotate and translate the corresponding clamp 160 between the engaged position and the disengaged position. More specifically, each fastener 164 can be configured to rotate in a first direction to rotate the clamp 160 to the engaged position (i.e., oriented orthogonal to the pair of adjacent beams 152 of the trailer 140) and advance the clamp 160 toward the cross member 124 to: pinch the lower flange 156 of each beam 152 in the pair of adjacent beams 152 between the clamp 160 and the cross member 124; and couple the battery assembly 120 to the trailer 140. Additionally, each fastener 164 can be configured to rotate in a second direction, opposite the first direction, to: rotate the clamp 160 to the disengaged position with the clamp 160 oriented parallel to the pair of adjacent beams 152 to permit passage of the clamp 160 between the gap defined between the pair of adjacent beams 152; and retract the clamp 160 from the cross member 124 to release the lower flange 156 of each beam 152 and decouple the battery assembly 120 from the trailer 140.

In one example, the battery assembly 120 can include a first cross member 124 defining a first aperture and a first clamp 160 arranged proximal an upper surface of the first cross member 124. The first clamp 160 includes a first end, a second end opposite the first end, and a midsection arranged between the first end and the second end and configured to receive a first fastener 164. A first pair of adjacent beams 152 of the trailer 140 includes a first beam 152 arranged on a left side of the first cross member 124 and a second beam 152 arranged on a right side of the first cross member 124. The first beam 152 defines a first lower flange 156 forming a first channel (e.g., a c-shaped channel) with a first upper flange 154 of the first beam 152 and the second beam 152 defines a second lower flange 156 forming a second channel with a second upper flange 154 of the second beam 152. Additionally, the first lower flange 156 and the second lower flange 156 define a gap therebetween.

In this example, an operator may: orient the first clamp 160 parallel to the first beam 152 and the second beam 152 (i.e., in the disengaged position); pass the first clamp 160 vertically through the first gap between the first lower flange 156 and the second lower flange 156; and engage a tool (e.g., an impact driver) with a head of the first fastener 164. The operator may then rotate the first fastener 164 in a first direction to: rotate the first clamp 160 about a longitudinal axis of the first fastener 164 by a rotational offset (e.g., 90 degrees) to orient the first clamp 160 orthogonal to the first beam 152 and the second beam 152; arrange the first end of the first clamp 160 within the first channel above the first lower flange 156; arrange the second end of the first clamp 160 within the second channel above the second lower flange 156; and advance the first clamp 160 toward the first cross member 124 to pinch the first lower flange 156 between the first end of the first clamp 160 and the upper surface of the first cross member 124 and to pinch the second lower flange 156 between the second end of the first clamp 160 and the upper surface of the first cross member 124.

In particular, the operator can access the head of the first fastener 164 from above the first cross member 124 (i.e., from below the floor 146 of the trailer 140, via a long socket extension (e.g., between 6 inches and 12 inches in length) coupled to the impact driver. The operator can insert the socket extension vertically through the first aperture of the first cross member 124 to engage the head of the first fastener 164 without reaching between the first beam 152 and the second beam 152 and without accessing the top surface of the floor 146 of the trailer 140. Therefore, a single operator can install the battery assembly 120 from a position below the trailer 140 (e.g., from a ground-level position) without overhead lifting equipment or a second operator.

Conversely, the operator may rotate the first fastener 164 in a second direction, opposite the first direction, to: retract the first clamp 160 from the first cross member 124 to release the first lower flange 156 from between the first end of the first clamp 160 and the first cross member 124 and to release the second lower flange 156 from between the second end of the first clamp 160 and the first cross member 124; rotate the first clamp 160 to the disengaged position (i.e., parallel to the first beam 152 and the second beam 152); and withdraw the first clamp 160 vertically through the first gap to decouple the battery assembly 120 from the first beam 152 and the second beam 152.

### 7.2 Variation: Longitudinal Adjustability

In one variation, the battery assembly 120 is configured to transiently install below the floor 146 of the trailer 140 at a selectable longitudinal position. In particular, each clamp 160 in the set of clamps 160 is operable in the disengaged position to permit the battery assembly 120 to translate along the longitudinal axis 143 of the trailer 140 and operable in the engaged position to fix the battery assembly 120 at a longitudinal position on the trailer 140.

For example, in a first configuration, an operator may: arrange the battery assembly 120 below the floor 146 of the trailer 140 at a first longitudinal position (e.g., facing a hitch of a tow vehicle); and rotate each fastener 164 in the set of fasteners 164 in the first direction to transition each clamp 160 in the set of clamps 160 into the engaged position to couple the battery assembly 120 to a first pair of adjacent beams 152 of the trailer 140 and thereby locate the battery assembly 120 at the first longitudinal position. In a second configuration, the operator may: rotate each fastener 164 in the set of fasteners 164 in the second direction to transition each clamp 160 in the set of clamps 160 into the disengaged position to decouple the battery assembly 120 from the first pair of adjacent beams 152; translate the battery assembly 120 along the longitudinal axis 143 of the trailer 140 to a second longitudinal position, different from the first longitudinal position; and rotate each fastener 164 in the set of fasteners 164 in the first direction to transition each clamp 160 in the set of clamps 160 into the engaged position to couple the battery assembly 120 to a second pair of adjacent beams 152 of the trailer 140 and thereby locate the battery assembly 120 at the second longitudinal position.

Therefore, the operator may selectively adjust the longitudinal position of the battery assembly 120 on the trailer 140 (e.g., to balance a weight distribution of the trailer 140, to accommodate a different length of the trailer 140, to install an additional battery assembly 120 on the trailer 140) without drilling, welding, or other irreversible modification of the trailer 140.

### 7.3 Multi-Trailer Compatibility

Generally, each clamp 160 in the set of clamps 160 is configured to couple the battery assembly 120 to different trailers exhibiting a range of flange geometries. In particular, beams 152 of the trailer 140 can exhibit different flange geometries across trailer manufacturers, such as different flange widths, flange thicknesses, and beam 152 heights. In particular, each clamp 160 is centered on the fastener 164 such that the first end and the second end of the clamp 160 extend laterally beyond the fastener 164 toward a first beam 152 and a second beam 152, respectively. The fastener 164 adjusts a vertical position of the clamp 160 relative to the cross member 124, such that the clamp 160 pinches lower flanges 156 of varying width, thickness, and beam height between the first end, the second end, and the upper surface of the cross member 124 without modification to the clamp 160.

In one example, a clamp 160 includes a first end, a second end opposite the first end, and a midsection arranged between the first end and the second end and configured to receive a first fastener 164. A first pair of adjacent beams 152 of a first trailer 140 includes a first beam 152 arranged on a left side of the cross member 124 and a second beam 152 arranged on a right side of the cross member 124. The first beam 152 defines a first lower flange 156 forming a first channel (e.g., a c-shaped channel) with a first upper flange 154 of the first beam 152 and the second beam 152 defines a second lower flange 156 forming a second channel with a second upper flange 154 of the second beam 152. In particular, in this example, the first pair of adjacent beams 152 exhibit a first flange geometry (e.g., a first flange thickness, a first flange width, a first beam 152 height). In this example, in a first configuration, the clamp 160 is configured to: pinch the first lower flange 156 between the first end and the cross member 124; and pinch the second lower flange 156 between the second end and the cross member 124.

Additionally, in this example, a second pair of adjacent beams 152 of a second trailer 140 includes a third beam 152 arranged on a left side of the cross member 124 and a fourth beam 152 arranged on a right side of the cross member 124. In particular, the second pair of adjacent beams 152 exhibit a second flange geometry (e.g., a second flange thickness, a second flange width, a second beam 152 height) different from the first flange geometry. In this example, in a second configuration, the clamp 160 is configured to: pinch a third lower flange 156 of the third beam 152 between the first end and the cross member 124; and pinch a fourth lower flange 156 of a fourth beam 152 between the second end and the cross member 124. Therefore, the battery assembly 120 can install on different trailers without modification to the clamp 160 geometry, thereby reducing deployment cost and complexity across a heterogeneous fleet of trailers 140.

### 7.4 Spacer

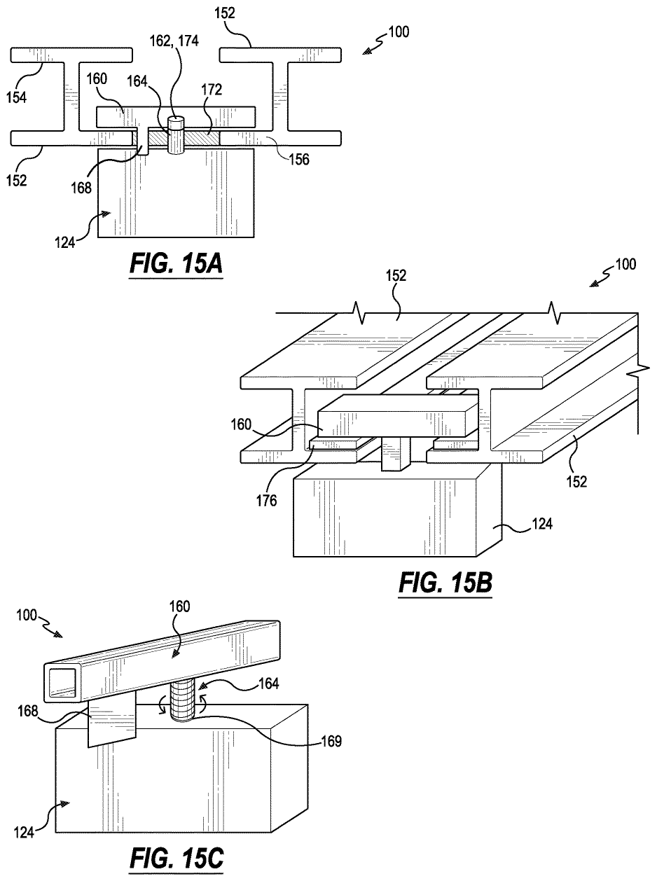

In one variation, as shown in FIG. 15A, each clamp 160 can include a spacer 172 configured to distribute a clamping force of a corresponding fastener 164 across the clamp 160. In particular, the spacer 172 can be interposed between the bottom surface of the clamp 160 and the upper surface of the cross member 124 while the clamp 160 occupies the engaged position. More specifically, the clamping force of the fastener 164 may concentrate at the first end and the second end of the clamp 160 such that the midsection of the clamp 160 (i.e., suspended over the gap) bows toward the upper surface of the cross member 124, thereby reducing the clamping force across the first lower flange 156 and the second lower flange 156. The spacer 172 can be configured to resist deformation of the midsection and thereby maintain substantially planar contact between the first end of the clamp 160 and the first lower flange 156 and between the second end of the clamp 160 and the second lower flange 156 across a surface of the first end and a surface of the second end, respectively.

In one example, the clamp 160 can include a spacer 172: proximal the bottom surface of the clamp 160; spanning a midsection of the clamp 160 (i.e., a portion of the clamp 160 spanning the gap defined between the pair of adjacent beams 152); and configured to distribute the clamping force of the fastener 164 across the midsection of the clamp 160. In particular, the spacer 172 can exhibit a spacer height (e.g., measured between the upper surface of the cross member 124 and the bottom surface of the midsection of the clamp 160), less than a dimension of each beam 152 in the pair of adjacent beams 152 (e.g., a distance between the upper flange 154 and the lower flange 156 of each beam 152) by a nominal offset (e.g., 0.015 inches, 0.5 millimeters) such that, as the fastener 164 advances the clamp 160 toward the cross member 124 in the engaged position, the first end of the clamp 160 contacts the first lower flange 156 and the second end of the clamp 160 contacts the second lower flange 156 while the spacer 172 resists compression of the midsection of the clamp 160 toward the upper surface of the cross member 124.

In another example, the spacer 172 can extend along a full width of the cross member 124 between the first end of the clamp 160 and the second end of the clamp 160 such that the spacer 172 distributes the clamping force of the fastener 164 across the full width of the cross member 124.

Thus, the spacer 172 can maintain substantially uniform contact between the first end of the clamp 160 and the first lower flange 156 and between the second end of the clamp 160 and the second lower flange 156, thereby distributing the clamping force of the fastener 164 across the first lower flange 156 and the second lower flange 156 (e.g., rather than concentrating the clamping force at inner edges of the lower flanges 156).

### 7.5 Mechanical Stops

In one variation, as shown in FIGS. 14A and 14B, each clamp 160 can include a stop 168 (e.g., a flange, a tab) configured to retain the clamp 160 in the engaged position (i.e., oriented orthogonal to the pair of adjacent beams 152) while the corresponding fastener 164 rotates. In particular, the stop 168 can abut the cross member 124 responsive to rotation of the clamp 160 by a rotational offset (e.g., 90 degrees) from the disengaged position to arrest further rotation of the clamp 160 and thereby retain the clamp 160 orthogonal to the pair of adjacent beams 152. In one example, the clamp 160 can include a stop 168: extending (or protruding) from the clamp 160 toward the upper surface of the cross member 124; and configured to abut the cross member 124 responsive to rotation of the clamp 160 by a rotational offset (e.g., 90 degrees) to retain the clamp 160 orthogonal to the pair of adjacent beams 152. More specifically, as the fastener 164 rotates in the first direction, friction between the fastener 164 and the nut 162 of the clamp 160 rotates the clamp 160 from the disengaged position toward the engaged position. Thus, without the stop 168, friction between the fastener 164 and the nut 162 can continue to rotate the clamp 160 past the engaged position, thereby disengaging the first end and the second end of the clamp 160 from the first lower flange 156 and the second lower flange 156 of the pair of adjacent beams 152. Accordingly, the stop 168 can abut the cross member 124 (or another surface of the battery assembly 120) at the engaged position to arrest further rotation of the clamp 160 and thereby maintain a rigid interface between the clamp 160 and the cross member 124 across the first lower flange 156 and the second lower flange 156 of the pair of adjacent beams 152.

In another example, the clamp 160 can include: a stop 168 configured to retain the clamp 160 in the engaged position; and a spring 169 (e.g., a torsion spring) configured to bias the clamp 160 toward the disengaged position. In this example, the stop 168 can be configured to abut the cross member 124 responsive to rotation of the clamp 160 by a rotational offset (e.g., 90 degrees) to retain the clamp 160 in the engaged position against the bias of the spring 169 while the fastener 164 remains engaged with the nut 162 of the clamp 160 and advanced toward the cross member 124. The spring 169 can be configured to bias the clamp 160 toward the disengaged position such that, when the fastener 164 is retracted from the cross member 124 (e.g., responsive to rotation of the fastener 164 in the second direction), the spring 169 rotates the clamp 160 from the engaged position back to the disengaged position. Therefore, upon release of the fastener 164, the spring 169 can return the clamp 160 to the disengaged position (i.e., oriented parallel to the pair of adjacent beams 152) such that the operator may withdraw the battery assembly 120 vertically through the gap between the pair of adjacent beams 152 without manually re-orienting each clamp 160.

In another example, as shown in FIG. 15C, the cross member 124 can include a stop 168 extending or protruding from the upper surface of the cross member 124 proximal the bottom surface of the clamp 160 and alongside a rotational path of the clamp 160 between the disengaged position and the engaged position. More specifically, the stop 168 can be arranged on the upper surface of the cross member 124 at an angular offset from the longitudinal axis of the fastener 164 such that, as the clamp 160 rotates from the disengaged position toward the engaged position, the bottom surface of the clamp 160 (or a corresponding feature on the bottom surface of the clamp 160) abuts the stop 168 to arrest further rotation of the clamp 160.

Thus, in this variation, the stop 168 can cooperate with the fastener 164 to rotate the clamp 160 from the disengaged position to the engaged position as the fastener 164 rotates in the first direction and to retain the clamp 160 in the engaged position as the fastener 164 continues to rotate in the first direction to advance the clamp 160 toward the cross member 124.

### 7.6 Friction Element

In one variation, the battery assembly 120 can include a set of friction elements 174 (e.g., a nylon insert, an elastomeric ring, a prevailing-torque feature), each friction element 174: interposed between a fastener 164 in the set of fasteners 164 and a nut 162 of a corresponding clamp 160 in the set of clamps 160; and configured to engage a set of threads of the fastener 164 to maintain contact between the fastener 164 and the nut 162 while the fastener 164 rotates. For example, each friction element 174 can be arranged within the nut 162 of the corresponding clamp 160 and exhibit an inner dimension less than a nominal outer dimension of the set of threads of the fastener 164 such that, as the fastener 164 engages the nut 162, the set of threads of the fastener 164 deforms the friction element 174 to generate torque between the fastener 164 and the nut 162. Thus, the friction element 174 can maintain contact between the set of threads of the fastener 164 and the nut 162 of the clamp 160 across a range of rotational positions of the fastener 164 such that rotation of the fastener 164 drives rotation of the clamp 160 regardless of manufacturing tolerances and wear conditions (e.g., as a result of manufacturing tolerance, galling, or wear).

### 7.7 Clamping Plate and Compliant Elements

In one variation, as shown in FIG. 15B, each clamp 160 can include a plate 176: arranged proximal an end of the clamp 160; and configured to distribute a clamping force of the clamp 160 across an area of the plate 176 exceeding a nominal cross-sectional area of the end of the clamp 160. In this variation, the clamp 160 can pinch the lower flange 156 of the beam 152 between the plate 176 and the cross member 124 rather than between the nominal end of the clamp 160 and the cross member 124. In particular, the plate 176 can exhibit a dimension (e.g., a surface area, a width, a length) exceeding a nominal dimension of the end of the clamp 160 such that the plate 176 distributes the clamping force of the clamp 160 across the plate 176 and across a portion of the lower flange 156 of the beam 152 contacted by the plate 176. For example, the plate 176 can exhibit a surface area exceeding a nominal cross-sectional area of the end of the clamp 160 by a ratio between two and ten (e.g., a ratio of three, a ratio of five), thereby reducing the peak contact stress between the clamp 160 and the lower flange 156 by a corresponding factor. More specifically, the clamping force of the fastener 164 may concentrate at the end of the clamp 160, thereby creating a localized stress concentration on the lower flange 156 of the beam 152 that may fatigue the beam 152. The plate 176 can distribute the clamping force across the plate 176 to reduce the peak stress applied to the lower flange 156 of the beam 152 by the clamp 160 and thereby extend the fatigue life of the beam 152 at the interface between the clamp 160 and the lower flange 156.

Additionally or alternatively, each end of the clamp 160 can define a radiused edge (e.g., a fillet radius between 0.125 inches and 0.25 inches) at the interface between the end of the clamp 160 and the lower flange 156 of the beam 152 to distribute the clamping force across a wider contact area and thereby reduce localized stress concentrations that may fatigue the lower flange 156 over time.

In another variation, the battery assembly 120 can include a set of compliant elements 178 (e.g., a rubber bushing, an elastomeric pad, a polymer isolator) configured to isolate the set of batteries 126 from lateral and torsional displacement of the trailer 140. In particular, the trailer chassis may flex or twist during operation as the trailer 140 traverses uneven road surfaces. Thus, rigidly coupling the battery assembly 120 to the trailer chassis may cause the battery assembly 120 to concentrate stress at the interface between each clamp 160 and the corresponding pair of adjacent beams 152, which may fatigue the beams 152 over time and risk structural failure of the floor 146 of the trailer 140.

In one example, the battery assembly 120 can include a set of compliant elements 178, each compliant element 178: interposed between a cross member 124 in the set of cross members 124 and the set of batteries 126; and configured to deform responsive to lateral displacement of the cross member 124 to isolate the set of batteries 126 from lateral displacement of the cross member 124. In particular, each compliant element 178 can be arranged between the cross member 124 and the set of batteries 126 and can include a material (e.g., a rubber, an elastomer, a polymer) exhibiting a stiffness less than a stiffness of the set of cross members 124. More specifically, as the trailer chassis flexes and twists during operation, the set of cross members 124 (rigidly coupled to the beams 152 of the trailer 140 via the set of clamps 160) can flex and twist with the trailer chassis. Each compliant element 178 can deform responsive to this flex and twist of the corresponding cross member 124 to isolate the set of batteries 126 from the flex and twist of the cross member 124 and thereby reduce stress applied to the set of batteries 126 and to the interface between the set of batteries 126 and the battery assembly 120.

### 8. Variation: Latches

In one variation, the battery assembly 120 includes a set of latches 133 configured to: transiently engage a subset of engagement features 144, in the first array of engagement features 144 on the left rail 147 and in the second array of engagement features 144 on the right rail 147; and to retain the battery assembly 120 below the floor 146 of the trailer 140. In this variation, each latch in the set of latches 133 can include a solenoid (e.g., an electromechanical solenoid, a pneumatic solenoid), or another electromechanical latch (e.g., an air pressure latch, a mechanical latch) operable in an engaged position and a disengaged position to transiently engage and/or disengage a corresponding engagement feature distributed along the left rail 147 and the right rail 147 of the trailer 140, as described above. However, each modular battery in the battery assembly 120 can define any other shape and couple to the motor 131 in any other way.

### 9. Modular Battery Assemblies

In one variation, shown in FIGS. 4A and 4B, the battery assembly 120 can include a set of modular batteries characterized by a combined battery capacity associated with a dry van trailer type to supply electrical energy to the motor 131 in a tow mode.

For example, an operator may select a set of (e.g., two) modular battery assemblies 120 characterized by a combined battery capacity within a target capacity range associated with a dry van trailer type to power the motor 131 (e.g., between 100 kilowatt-hours and 400 kilowatt-hours). In this example, the operator or a machine may install the battery frame and a first battery assembly 120, installed in the battery frame, below the floor 146 of the trailer 140 adjacent a proximal end of the bogie 130 (e.g., facing a hitch of a tow vehicle) to engage the set of latches 133 of the first battery assembly 120 with corresponding engagement features 144 on the left rail 147 and the right rail 147 of the dry van trailer 140. Then, the user or the machine may install a second battery assembly 120, installed in the battery frame, below the floor 146 of the trailer 140 proximal a distal end of the bogie 130 opposite the first battery assembly 120 to engage a second set of latches 133 of the second battery assembly 120 with corresponding engagement features 144 on the left rail 147 and the right rail 147 of the dry van trailer 140. Once the controller 150 enters a tow mode, the controller 150 can: trigger the first battery assembly 120 to supply electrical energy via a power cable to the motor 131 of the dry van trailer type; and trigger the second battery assembly 120 to supply electrical energy to the motor 131 to output torque to the driven axle 137 in a tow mode.

In another variation, shown in FIG. 4C, the battery assembly 120 can include a set of (e.g., two) battery assemblies characterized by a combined battery capacity associated with a refrigerated trailer type to supply electrical energy to the motor 131 in a tow mode and to supply electrical energy to a refrigeration system of the trailer 140 to maintain a target temperature of perishable goods stored within the trailer 140 in a tow mode.

For example, the operator may select a set of (e.g., two) battery assemblies 120 characterized by a combined battery capacity within a target capacity range associated with a refrigerated trailer type to power the motor 131 (e.g., between 280 kilowatt-hours and 750 kilowatt-hours) and electrically couple the set of battery assemblies 120 in parallel. Similar to the example above, the user or machine may: install the first battery assembly 120 below the floor 146 of the trailer 140 adjacent a proximal end of the bogie 130 (e.g., facing a hitch of a tow vehicle); electrically couple the first battery assembly 120 to the motor 131 via a first power cable housed in the drag chain; install the second battery assembly 120 below the floor 146 of the trailer 140 proximal a distal end of the bogie 130 opposite the first battery assembly 120; and electrically couple the second battery assembly 120 to a refrigeration system of the trailer 140 via a second power cable. The controller 150 can then trigger the first battery assembly 120 to supply a first electrical energy flux to the motor 131 to output torque to the driven axle 137; trigger the second battery assembly 120 to supply a second electrical energy flux, different from the first electrical energy flux, to the refrigeration system to maintain a target temperature of the trailer 140 in the tow mode; and trigger the motor 131 to supply electrical energy to the first battery assembly 120 and the second battery assembly 120 to charge the first battery assembly 120 and the second battery assembly 120 in the regenerative braking mode.

Alternatively, the operator may select a set of (e.g., two) battery assemblies 120 characterized by a combined battery capacity within a target capacity range associated with a refrigerated trailer type to power the motor 131 (e.g., between 280 kilowatt-hours and 750 kilowatt-hours) and electrically couple the set of battery assemblies 120 in parallel. The controller 150 can then trigger the first battery assembly 120 and the second battery assembly 120 to supply a first electrical load to the motor to output torque to the driven axle 137; trigger the first battery assembly 120 and the second battery assembly 120 to supply a second electrical load, different from the first electrical load, to the refrigeration system to maintain a target temperature of the trailer 140 in the tow mode; and trigger the motor 131 to supply electrical energy to the first battery assembly 120 and the second battery assembly 120 to charge the first battery assembly 120 and the second battery assembly 120 in the regenerative braking mode.

Thus, the system 100 can include additional battery assemblies 120 to supply electrical energy to the refrigeration system of a refrigerated trailer 140 to maintain a temperature of goods (e.g., perishable goods) as the trailer 140 transports these goods from a start location to a termination location.

Therefore, the battery assembly 120 can include a set of modular batteries 120 that enables a user to select a battery assembly 120 characterized by a battery capacity that falls within a target capacity range associated with a particular trailer type (e.g., a dry van trailer 140, a refrigerated trailer 140) and/or to supply electrical energy to additional systems of the trailer 140.

### 10. Tow Mode

Generally, the user (e.g., an operator, a driver, a yard manager) or a machine (e.g., a forklift) couples the hitch (e.g., a fifth wheel) of a tow vehicle to the kingpin 110 and the controller 150 can identify a coupling event between the kingpin 110 (e.g., via a signal from a force sensor) and the hitch of the tow vehicle. In particular, the controller 150 can interface with the integrated controller to: detect an initial force impulse applied to the kingpin; interpret the initial force impulse as a coupling event with the hitch of the tow vehicle; and, in response to interpreting the initial force impulse as the coupling event with the hitch of the tow vehicle, enter a tow mode.

In one implementation, in tow mode, the controller 150 can detect conditions of the trailer 140 such as: a direction of motion of the trailer 140; a tractor-trailer (e.g., a steering angle); a speed of the trailer 140; an incline angle of the trailer 140 (e.g., a grade of a ground surface); a location of the trailer 140; forces applied to the kingpin 110 (e.g., lateral forces, longitudinal forces, vertical forces, total forces); a charge state of the battery assembly 120 coupled to the trailer 140; and/or a weight of the trailer 140 on the driven axle 137. The controller 150 can then: calculate a target preload force proportional to and/or inversely proportional to the condition of the trailer 140; and trigger the motor 131 to increase torque output and/or reduce torque output in the direction of motion of the trailer 140 to decrease a difference between the target preload force and a total force applied to the kingpin (e.g., an actual force) to control the trailer 140 in conjunction with the tow vehicle.

More specifically, during a given time period (e.g., thirty seconds, five minutes, ten minutes, one hour), the controller 150 can interface with the integrated controller of the kingpin 110 to: detect a direction of motion of the trailer 140; detect a weight distribution (e.g., a load on each axle) of the trailer 140; and set a target preload force opposite the direction of motion based on the weight distribution; detect a speed of the trailer 140; and, in response to the speed exceeding a lower speed limit (e.g., 20 miles per hour, 30 miles per hour) enable torque output and regenerative braking at the motor 131. Then, the controller 150 can: calculate a speed variance over the time window based on the speed of the trailer 140; adjust target torque output inversely proportional to the speed variance; and adjust the target preload force proportional to the speed variance. The controller 150 can further: detect a location of the trailer 140; retrieve a georeferenced location or a low-emissions region from a drive route assigned to the trailer 140; and, in response to the location falling within the threshold distance of the low-emissions region, increase target torque output and decrease the target preload force. Alternatively, in response to the location falling outside of a threshold distance of the low-emissions region, the controller 150 can decrease target torque output and increase the target preload force.

Additionally, the controller 150 can: detect an incline angle of the trailer 140; adjust target torque output proportional to the incline angle of the trailer 140; and adjust target preload force inversely proportional to the incline angle of the trailer 140. Similarly, the controller 150 can: detect a decline angle of the trailer 140; adjust target torque output inversely proportional to the decline angle of the trailer 140; and adjust the target preload force inversely proportional to the decline angle. The controller 150 can: detect a charge state of a battery assembly 120 coupled to the trailer 140; adjust target torque output proportional to the charge state of the battery assembly 120; adjust target regenerative braking inversely proportional to the charge state of the battery assembly 120; and adjust the target preload force inversely proportional to the charge state of the battery assembly 120.

Furthermore, the controller 150 can: detect a longitudinal force applied to the kingpin by a hitch of a tow vehicle (e.g., via a first strain gauge); detect a lateral force applied to the kingpin by the hitch (e.g., via a second strain gauge); calculate a tractor-trailer angle (e.g., a steering angle) based on the longitudinal force and the lateral force; adjust target torque output inversely proportional to the tractor-trailer angle; and adjust the target preload force proportional to the tractor-trailer angle. The controller 150 can then: calculate a total force applied to the kingpin 110 by the hitch based on the lateral force and the longitudinal force. Accordingly, in response to the total force exceeding the target preload force, the controller 150 can trigger a motor 131, arranged in the bogie 130 to increase torque output in the direction of motion of the trailer 140 to decrease a difference between the target preload force and a total force applied to the kingpin (e.g., an actual force) to control the trailer 140 in conjunction with the tow vehicle. Alternatively, in response to the total force falling below the target preload force, the controller 150 can trigger the motor 131 to reduce torque output in the direction of motion of the trailer 140 to decrease a difference between the target preload force and the total force applied to the kingpin (e.g., an actual force) to control the trailer 140 in conjunction with the tow vehicle.

Therefore, the controller 150 can leverage the dynamic target preload force, torque output, and regenerative braking: to prevent a jackknife event between the tow vehicle and the trailer 140 (e.g., tow vehicle brakes to a stop and the trailer 140 continues to move toward and push the tow vehicle or torque applied to the kingpin); to reduce emissions by the tow vehicle; to decrease fuel consumption by the tow vehicle; to extend the life of each battery assembly 120 coupled to the trailer 140; and to enable a driver of the tow vehicle to apply minimal to no brake force via the mechanical or pneumatic braking system to the trailer 140 in tow mode.

### 10.1 Dynamic Target Preload Force: Tractor-Trailer Angle

In one implementation, the controller 150 can detect a direction of motion and a speed of the trailer 140, detect a lateral force and a longitudinal force applied to the kingpin by the hitch, and calculate a tractor-trailer angle as conditions of the trailer 140. The controller 150 can leverage these conditions to selectively increase, decrease, or disable torque output and adjust the target preload force.

For example, the controller 150 can: detect a first longitudinal force applied to a kingpin, arranged on a proximal end of a trailer 140, by a hitch of a tow vehicle (e.g., via a first strain gauge); detect a first lateral force applied to the kingpin by the hitch (e.g., via a second strain gauge); detect a first speed and a first direction of motion of the trailer 140 (e.g., 30 miles per hour in forward direction via an inertial measurement unit); calculate a first tractor-trailer angle, between longitudinal axes of the trailer 140 and the tow vehicle, based on the first longitudinal force and the first lateral force; calculate a first total force, applied to the kingpin by the hitch, based on the first longitudinal force and the first lateral force; calculate a first target preload force opposite the first direction of motion (e.g., reverse direction) and proportional to the first tractor-trailer angle; trigger a motor 131, arranged in the bogie 130 located proximal a distal end of the trailer 140, to reduce torque output in the first direction of motion (e.g., forward direction) to decrease a first difference between the first total force and the first target preload force, in response to the first speed of the trailer 140 (e.g., 30 miles per hour) exceeding a first threshold speed (e.g., a lower speed limit of 20 miles per hour) and in response to the first total force falling below the first target preload force.

During a second time period, the controller 150 can: detect a second longitudinal force applied to the kingpin by the hitch; detect a second lateral force applied to the kingpin by the hitch; detect a second speed and a second direction (e.g., forward direction) of the trailer 140 (e.g., via an inertial measurement unit); calculate a second total force applied to the kingpin by the hitch based on the second longitudinal force and the second lateral force; calculate a second target preload force opposite the second direction of motion (e.g., a reverse direction) and proportional to the second tractor-trailer angle; and trigger the motor 131 to increase torque output in the second direction of motion (e.g., forward direction) to decrease a second difference between the second total force and the second target preload force, in response to the second speed exceeding the first threshold speed (e.g., 30 miles per hour) and in response to the second total force exceeding the second target preload force.

During a third time period, the controller 150 can: detect a third longitudinal force applied to the kingpin by the hitch; detect a third lateral force applied to the kingpin by the hitch; detect a third speed and a third direction of motion of the trailer 140 (e.g., a forward direction); calculate a third total force applied to the kingpin by the hitch of the tow vehicle based on the third longitudinal force and the third lateral force; and, in response to the third speed of the trailer 140 falling below a second threshold speed (e.g., 50 miles per hour), triggering the motor 131 to disable torque output in the third direction of motion. During a fourth time period, the controller 150 can: detect a fourth longitudinal force applied to the kingpin by the hitch; detect a fourth lateral force applied to the kingpin by the hitch; detect a fourth speed and a fourth direction of motion of the trailer 140 (e.g., 20 miles per hour in forward direction); in response to the fourth speed of the trailer 140 falling below the lower speed limit (e.g., 25 miles per hour), accessing a nominal low-speed preload force; calculating a fourth total force applied to the kingpin by the hitch based on the fourth longitudinal force and the fourth lateral force; and, in response to the fourth total force exceeding the nominal low-speed preload force, trigger the motor 131 to increase torque output in the fourth direction of motion (e.g., forward direction) of the tow vehicle to decrease a third difference between the fourth total force and the nominal low-speed preload force.

### 10.1.1 Dynamic Target Preload Force: Speed Variance+Duration

In one variation, the controller 150 can: calculate a first speed variance of the trailer 140 during the first time period based on the first speed; calculate the first target preload force proportional to the first tractor-trailer angle and proportional to the first speed variance; calculate the second tractor-trailer angle less than the first tractor-trailer angle; calculate a second speed variance of the trailer 140 during the second time period based on the second speed, the second speed variance greater than the first speed variance; and calculate the second target preload force, approximating the first target preload force, proportional to the second tractor-trailer angle and proportional to the second speed variance.

In another variation, the controller 150 can calculate a duration of the trailer 140 exhibiting the first speed during the first time period and exhibiting the first speed during a next time period. The controller 150 can then calculate the target preload force inversely proportional to these durations for the corresponding time period.

For example, the controller 150 can detect a first speed and a first direction of motion of the trailer 140 (e.g., 30 miles per hour in forward direction via an inertial measurement unit) and detect a first total force applied to the kingpin by the hitch during a first time period. The controller 150 can then: detect a first duration of the trailer 140 exhibiting the first speed; and calculate a first target preload force opposite the direction of motion of the tow vehicle and inversely proportional the first duration. During a second time period, the controller 150 can: detect a second speed of the trailer 140 corresponding to the first speed of the trailer 140; detect a second duration of the trailer 140 exhibiting the second speed; and, in response to the second duration exceeding the first duration, calculate a second target preload force, less than the first target preload force, opposite the direction of motion and inversely proportional the second duration. The controller 150 can then trigger the motor 131 to reduce torque output in the first direction of motion (e.g., forward direction) to decrease a first difference between the first total force and the first target preload force in response to the first total force falling below the first target preload force.

Therefore, the controller 150 can leverage the target preload force at the kingpin 110 to control the trailer 140 as the speed of the trailer 140 and a duration of the speed fluctuates during a drive route and thereby enable a user (e.g., a driver) of the tow vehicle to apply minimal to no assistance to the trailer 140.

### 10.1.2 Dynamic Target Preload Force: Stiction+Regenerative Braking

In one variation, the controller 150 can detect a difference between the first total force and a second total force (e.g., a force impulse) for a duration of time while the trailer 140 is in motion. The controller 150 can then leverage the speed of the trailer 140, a threshold difference, and a threshold duration of time to identify a stiction event between the kingpin 110 and the hitch of the tow vehicle.

For example, the controller 150 can, during a first time period: detect a first total force applied to the kingpin 110 by the hitch of the tow vehicle; detect a speed and a direction of motion of the trailer 140 (e.g., 30 miles per hour in forward direction via an inertial measurement unit); based on the total force, calculate a tractor-trailer angle, between longitudinal axes of the trailer 140; calculate a target preload force opposite the first direction of motion (e.g., reverse direction) and proportional to the first tractor-trailer angle; trigger the motor 131 to reduce torque output in the direction of motion (e.g., forward direction) to decrease a difference between the total force and the target preload force, in response to the speed of the trailer 140 (e.g., 30 miles per hour) exceeding a threshold speed (e.g., a lower speed limit of 25 miles per hour) and in response to the total force falling below the target preload force.

During a second period of time, the controller 150 can: detect a second total force applied to the kingpin 110 by the hitch of the tow vehicle; detect a speed and a direction of motion of the trailer 140 (e.g., 30 miles per hour in forward direction via an inertial measurement unit); detect a difference between the first total force and the second total force for a duration of time (e.g., 5 minutes); and, in response to the difference exceeding a threshold difference and in response to the duration exceeding a threshold duration of time, identify a stiction event between the kingpin 110 and the hitch of the tow vehicle and trigger the motor 131 to regeneratively brake the trailer 140. The controller 150 can then detect a third total force applied to the kingpin 110; and trigger the motor 131 to increase torque output in the direction of motion (e.g., forward direction) to decrease a difference between the third total force and the target preload force in response to the third total force exceeding the target preload force.

Therefore, the controller 150 can monitor forces applied to the kingpin 110 to identify a stiction event between the kingpin 110 and the hitch of the tow vehicle and trigger the motor 131 to selectively apply a regenerative braking force to slow motion of the trailer 140.

### 10.2 Dynamic Target Preload Force: Incline Angle of Trailer

In one implementation, the controller 150 can detect an incline angle of the trailer 140 representing a grade of the road (e.g., 5% grade, 10% grade) as a condition of the trailer 140 and then leverage the incline angle to selectively adjust the target preload force. Additionally, in response to the incline angle exceeding a threshold incline angle (e.g., trailer 140 is moving up a hill), the controller 150 can decrease the target preload force. Alternatively, in response to the incline angle falling below the threshold incline angle (e.g., trailer 140 is moving down a hill), the controller 150 can increase the target preload force.

For example, during a first time period, the controller 150 can: detect a first longitudinal force applied to the kingpin 110 by the hitch; detect a first lateral force applied to the kingpin by the hitch of the tow vehicle; detect a first direction of motion of the trailer 140 (e.g., a forward direction); detect a first incline angle of the trailer 140 (e.g., 2.86 degrees); calculate a first total force, applied to the kingpin by the hitch of the tow vehicle, based on the first longitudinal force and the first lateral force; calculate a first target preload force opposite the first direction of motion (e.g., a reverse direction) and proportional to the first incline angle; and, in response to the first total force falling below the first target preload force, trigger the motor 131 to reduce torque output in the first direction of motion (e.g., forward direction) to decrease a first difference between the first total force and the first target preload force.

During a second time period, the controller 150 can: detect a second force applied to the kingpin by the hitch of the tow vehicle; detect a decline angle of the trailer 140 (e.g., −0.573 degrees); calculate a second target preload force opposite the direction of motion of the tow vehicle and inversely proportional to the decline angle; and, in response to the second force falling below the second target preload force, trigger the motor 131 to increase torque output opposite the direction of motion (e.g., reverse direction) to decrease the second difference between the second force and the second target preload force.

Alternatively, the controller 150 can: calculate a second total force applied to the kingpin by the hitch of the tow vehicle based on the second longitudinal force and the second lateral force; calculate a second target preload force opposite the second direction of motion and proportional the decline angle of the trailer 140; and, in response to the second total force exceeding the second target preload force, trigger the motor 131 to regeneratively brake a driven axle 137 to slow motion of the trailer 140 and to decrease a second difference between the second total force and the second target preload force.

Therefore, the controller 150 can selectively increase or decrease the target preload force and the target torque output by the motor 131 as the location of the trailer 140 fluctuates during the drive route. Additionally, the controller 150 can also leverage the target preload force and the location of the trailer 140 to enable a user (e.g., a driver) of the tow vehicle to apply minimal to no brakes to the trailer 140.

### 10.3 Dynamic Target Preload Force: Drive Route+Location of Trailer

In one variation, the controller 150 can detect a location of the trailer 140 as a condition of the trailer 140 and then leverage the location and a drive route assigned to the trailer 140 to selectively increase or decrease the target preload force.

Furthermore, an operator may define a start location and an end location for a drive route and upload this drive route to a user portal. The controller 150 can then: access the drive route; estimate a set of legs between the start location and the end location for the drive route; and populate each leg of the drive route with a time window, a corresponding georeferenced location, and emission conditions associated with the georeferenced location (e.g., a low-emissions region). The computer system can then access this drive route at the start of the tow mode. The controller 150 can also access signals from a gyroscope or an inertial sensor to detect locations of the trailer 140 during the drive route.

For example, during a first time period, the controller 150 can: detect a first longitudinal force applied to the kingpin 110 by the hitch of the tow vehicle; detect a first lateral force applied to the kingpin by the hitch; detect a first direction of motion and first speed of the trailer 140 (e.g., a forward direction); detect a first tractor-trailer angle; calculate a first total force, applied to the kingpin by the hitch, based on the first longitudinal force and the first lateral force; calculate a first target preload force opposite the first direction of motion (e.g., a reverse direction) and proportional to the tractor-trailer angle; and, in response to the first total force falling below the first target preload force, trigger the motor 131 to reduce torque output in the first direction of motion (e.g., forward direction) to decrease a first difference between the first total force and the first target preload force.

During a second time period, the controller 150 can: detect a second longitudinal force applied to the kingpin 110 by the hitch of the tow vehicle; detect a second lateral force applied to the kingpin by the hitch; detect a second direction of motion and a second speed of the trailer 140 (e.g., a forward direction); detect a second tractor-trailer angle; retrieve a first low-emissions region from a drive route assigned to the trailer 140; detect a first location of the trailer 140 (e.g., via an inertial measurement unit); calculate a second total force, applied to the kingpin by the hitch, based on the second longitudinal force and the second lateral force; calculate a second target preload force opposite the second direction of motion (e.g., a reverse direction) and proportional to the second tractor-trailer angle; and, in response to the first location falling within the threshold distance of the low-emissions region and in response to the second speed exceeding the first threshold speed (e.g., 25 miles per hour) and in response to the second total force exceeding the target preload force, trigger the motor 131 to reduce torque output in the second direction of motion (e.g., forward direction) to decrease a second difference between the first total force and the first target preload force.

During a third time period, the controller 150 can: detect a third speed and a third direction of motion of the trailer 140 (e.g., forward direction); retrieve a last georeferenced location (e.g., a storage yard) from the drive route assigned to the trailer 140; detect a second location of the trailer 140; and, in response to the third speed of the trailer 140 falling below the first threshold speed and in response to the second location of the trailer 140 falling within the threshold distance of the last georeferenced location (e.g., a storage yard), trigger the motor 131 to disable torque output in the third direction of motion (e.g., forward direction).

Therefore, the controller 150 can selectively increase or decrease the target preload force and the target torque output by the motor 131 as the location of the trailer 140 fluctuates during the drive route. Additionally, the controller 150 can also leverage the target preload force and the location of the trailer 140 to enable a user (e.g., a driver) of the tow vehicle to apply minimal to no brakes to the trailer 140.

### 10.4 Dynamic Target Preload Force: Charge State of Battery

In one variation, the controller 150 can detect a “real-time” battery status (or a “charge state”) of each battery in the battery assembly 120 coupled to the trailer 140. The controller 150 can then detect a charge state of the battery assembly 120 (e.g., a numerical value, a percentage, a level) as a condition of the trailer 140 and leverage this charge state of the battery assembly 120 to selectively adjust the target preload force.

For example, during a first time period, the controller 150 can: detect a first longitudinal force applied to the kingpin 110 by the hitch of the tow vehicle; detect a first lateral force applied to the kingpin by the hitch; detect a first direction of motion and a first speed of the trailer 140 (e.g., a forward direction); detect a first charge state of the battery assembly 120 (e.g., 55%); detect a first tractor-trailer angle; calculate a first total force, applied to the kingpin by the hitch, based on the first longitudinal force and the first lateral force; calculate a first target preload force opposite the first direction of motion (e.g., a reverse direction) proportional to the tractor-trailer angle and inversely proportional to the first charge state of the battery assembly 120; and, in response to the first total force falling below the first target preload force, trigger the motor 131 to reduce torque output in the first direction of motion (e.g., forward direction) to decrease a first difference between the first total force and the first target preload force.

During a second time period, the controller 150 can: detect a second longitudinal force applied to the kingpin 110 by the hitch of the tow vehicle; detect a second lateral force applied to the kingpin by the hitch; detect a second direction of motion and a second speed of the trailer 140 (e.g., a forward direction); detect a second tractor-trailer angle less than the first tractor-trailer angle; detect a second charge state of the battery assembly 120 (e.g., 75%) greater than the first charge state of the battery assembly 120 (e.g., 55%); calculate a second total force, applied to the kingpin by the hitch, based on the second longitudinal force and the second lateral force; calculate a second target preload force opposite the second direction of motion (e.g., a reverse direction) proportional to the second tractor-trailer angle and inversely proportional to the second charge state of the battery assembly 120 (e.g., 75%); and, in response to the second total force exceeding the target preload force, trigger the motor 131 to reduce torque output in the second direction of motion (e.g., forward direction) to decrease a second difference between the first total force and the first target preload force.

Additionally or alternatively, the controller 150 can access the drive route assigned to the trailer 140 and predict a charge state of the battery assembly 120 at the start of the tow mode. Then for each leg of the drive route, the controller 150 can autonomously increase or decrease the target preload force at the kingpin 110 proportional the predicted charge state of the battery assembly 120 associated with each leg of the drive route.

Therefore, the controller 150 can leverage a “real-time” charge state or a predicted charge state of the battery assembly 120 to selectively increase or decrease the target preload force and thereby increase the life of the battery assembly 120 and reduce emissions by the tow vehicle.

### 11. Regenerative Braking Mode

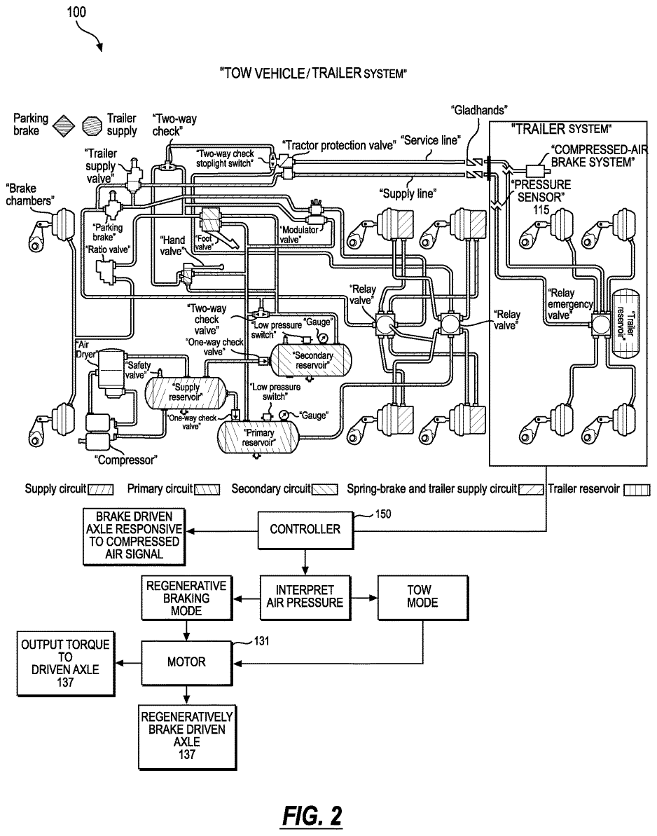

In one variation, as shown in FIG. 2, the controller 150 can leverage signals output by a pressure sensor 115 coupled to a spring-brake relay of a tow vehicle to automatically transition from the tow mode to the regenerative braking mode and vice versa. Further, in response to the air pressure exceeding a threshold air pressure, the controller 150 can maintain the tow mode and trigger the battery assembly 120 to supply electrical energy to the motor 131 to output torque to the driven axle 137. Alternatively, in response to the air pressure falling below the threshold air pressure, the controller 150 can: identify the air pressure from the tow vehicle as braking from the pneumatic or mechanical system; and trigger the motor 131 to supply electrical energy to the battery assembly 120 to regeneratively brake the driven axle 137 and charge the battery assembly 120.

For example, the system 100 can include a pressure sensor 115 coupled to a spring-brake relay of a tow vehicle and configured to output signals corresponding to air pressures at the spring-brake relay from an air supply of the tow vehicle. At a first time, the controller 150 can then: access a first signal from the pressure sensor 115; interpret a first air pressure at the spring-brake relay based on the first signal; identify absence of braking from the pneumatic or mechanical system and, in the tow mode, trigger the battery assembly 120 to supply electrical energy to the motor 131 to output torque to the driven axle 137. At a second time, the controller 150 can: access a second signal from the pressure sensor 115; interpret a second air pressure at the spring-brake relay based on the second signal; detect a difference between the first air pressure and the second air pressure; and, in response to detecting the difference falling below a threshold pressure difference, enter a regenerative braking mode.

Additionally, in the regenerative braking mode, the system 100 can leverage signals from a pressure sensor 115 coupled to the emergency brake line (e.g., a supply brake line) of the trailer 140 to enter a maximum regenerative braking mode. In particular, in response to an air pressure in the emergency brake line exceeding a threshold air pressure, the controller 150 can: identify absence of braking from the pneumatic or mechanical system for the emergency brake line; and enter a maximum regenerative braking mode.

For example, the system 100 can further include a pressure sensor 115 configured to output signals corresponding to air pressure of an emergency brake line at the trailer 140 from a tow vehicle. Then, the controller 150 can: access a first signal from the pressure sensor 115; interpret a first air pressure of the emergency brake line of the trailer 140 based on the first signal; and, in response to the first air pressure exceeding a threshold air pressure, identify absence of braking from the pneumatic or mechanical system for the emergency brake line and enter a maximum regenerative braking mode. Then, in the maximum regenerative braking mode, the controller 150 can trigger the motor 131 to supply a maximum electrical energy flux to the first battery assembly 120 to regeneratively brake the driven axle 137 and charge the battery assembly 120.

Therefore, the controller 150 can leverage signals output by pressure sensors 115 to automatically transition between the tow mode and the regenerative braking mode.

11.1 Variation: Mechanical Braking Vs. Regenerative Braking

In one variation, the controller 150 can detect a charge state of the battery assembly 120 (e.g., a numerical value, a percentage, a level, a capacity) as a condition of the trailer 140 and leverage this charge state of the battery assembly 120 to selectively adjust the ratio of mechanical braking and regenerative braking force output by the motor 131 in regenerative braking mode. Further, the controller 150 can leverage a proportion of the capacity of the battery assembly 120 to power an emergency braking system (e.g., an anti-lock braking system) of the trailer 140 in the regenerative braking mode and thus, prevent a lockup event at the wheels of the trailer 140.

For example, the controller 150 can: access a capacity of the battery (e.g., 100%); calculate a minimum capacity of the battery to power the emergency brake system of the trailer 140 in the regenerative braking mode (e.g., 10%); define a threshold charge state (e.g., 50%) for the battery in regenerative braking mode based on a remaining proportion of the capacity (e.g., 90%); and leverage the threshold charge state to increase or decrease regenerative braking by the motor 131 to the driven axle 137 in regenerative braking mode. Thus, the controller 150 can implement methods and techniques described below to detect absence of a braking force from a pneumatic or mechanical brake system of the tow vehicle, identify a brake failure at the pneumatic or mechanical brake system, and leverage the minimum capacity of the battery to power the emergency brake system of the trailer 140 to slow motion of the trailer 140.

In one implementation, the controller 150 can detect a direction of motion of the trailer 140, implement methods and techniques described above to track the charge state of the battery, and selectively increase or decrease the regenerative braking force output by the motor 131 as a function of the charge state of the battery. For example, the controller 150 can: detect a forward direction of motion of the trailer 140; detect a charge state of the battery; and, in response to the charge state falling below a threshold charge state, trigger the motor 131 to increase a regenerative braking force, opposite the direction of motion, to the driven axle 137. Alternatively, the controller 150 can: detect a charge state of the battery; and, in response to the charge state of the battery exceeding the threshold charge state, trigger the motor 131 to reduce the regenerative braking force, opposite the direction of motion, to the driven axle 137.

### 11.2 Variation: Compressed-Air-Brake System+Traction

In one variation, as shown in FIG. 2, the bogie 130 can further include a compressed-air-brake system configured to couple to a gladhand of a brake line from a tow vehicle coupled to the trailer 140 and brake the driven axle 137 responsive to air signals received from the tow vehicle via the gladhand. Further, the system 100 can include a set of wheel speed sensors. Each wheel speed sensor can couple to a corresponding driven wheel of the bogie 130 and the controller 150 can leverage signals output from each wheel speed sensor to track traction between the driven wheels of the bogie 130 and a ground surface and trigger the motor 131 to regeneratively brake the trailer 140. Alternatively, the controller 150 can access signals output from sensors coupled to an anti-lock braking system of the tow vehicle to automatically trigger the motor 131 to apply a braking force to the driven axle 137 via the pneumatic or mechanical brake system of the trailer 140 and/or via regenerative braking.

For example, a user (e.g., a technician, an operator) may manually couple an emergency brake line (e.g., a supply brake line) and a service brake line (e.g., a control brake line) of the trailer 140 to a compressed air supply line of a tractor via a set of hose couplings (e.g., a gladhand coupler, a gladhand connector). The user may then couple a compressed-air-brake system of the bogie 130 to the gladhand coupling between the tractor and the trailer 140. Then, in response to detecting an air signal from the tractor via the gladhand at the compressed-air-brake system, the controller 150 can selectively brake the driven axle 137 via the pneumatic or mechanical brake system of the trailer 140. The controller 150 can further implement methods and techniques described below to enter a regenerative braking mode and alternate the proportion of braking between the pneumatic or mechanical brake system of the trailer 140 and regenerative braking.

In one implementation, the controller 150 can further leverage signals output by each wheel speed sensor to track a level of traction of the left driven wheel 138 and the right driven wheel 139 with a ground surface below the trailer 140 and selectively increase or decrease regenerative braking of the left driven wheel 138 and the right driven wheel 139 based on the level of traction.

For example, the controller 150 can: access an air signal from the tow vehicle via the gladhand; interpret an air pressure from the tow vehicle; and, in response to the air pressure exceeding a threshold air pressure, identify a braking force applied to the driven axle 137 from the pneumatic or mechanical brake system of the trailer 140 and trigger the motor 131 to disable torque output to the driven axle 137 in tow mode. Then, the controller 150 can interface with the integrated controller of the kingpin 110 to: detect a force applied to the kingpin by the hitch based on the second signal output by the set of force sensors; and access a target preload force on the kingpin 110. Then, in response to the force exceeding the target preload force, the controller 150 can trigger the motor 131 to supply a first electrical energy flux to the battery assembly 120 in the regenerative braking mode. The controller 150 can then: detect loss of traction at the driven axle 137 (e.g., between the left driven wheel 138 and a ground surface) based on a signal output by the set of wheel speed sensors; and, in response to detecting loss of traction at the driven axle 137 and in response to the force exceeding the target preload force, trigger the motor 131 to supply a second electrical energy flux, less than the first electrical energy flux, to the first battery assembly 120 in the regenerative braking mode to reduce the proportion of regenerative braking output to the driven axle 137.

In the regenerative braking mode, the controller 150 can then: detect a presence of traction at the driven axle 137 (e.g., between the left driven wheel 138 and the ground surface) based on a next signal output by the set of wheel speed sensors; and, in response to detecting presence of traction at the driven axle 137, automatically trigger the motor 131 to supply the first electrical energy flux to the battery assembly 120 to increase regenerative braking to the driven axle 137 (e.g., the left driven wheel 138).

Therefore, the controller 150 can leverage air signals received from the tow vehicle via the gladhand, the target preload force, and signals output from the set of wheel speed sensors to automatically apply a proportion of braking force to the driven axle 137 from the pneumatic or mechanical brake system of the trailer 140 and/or regeneratively brake the driven axle 137, and thereby, maintain traction between the driven wheels of the trailer 140 and a ground surface.

### 11.3 Variation: Air-Ride Suspension System+Weight on Driven Axle

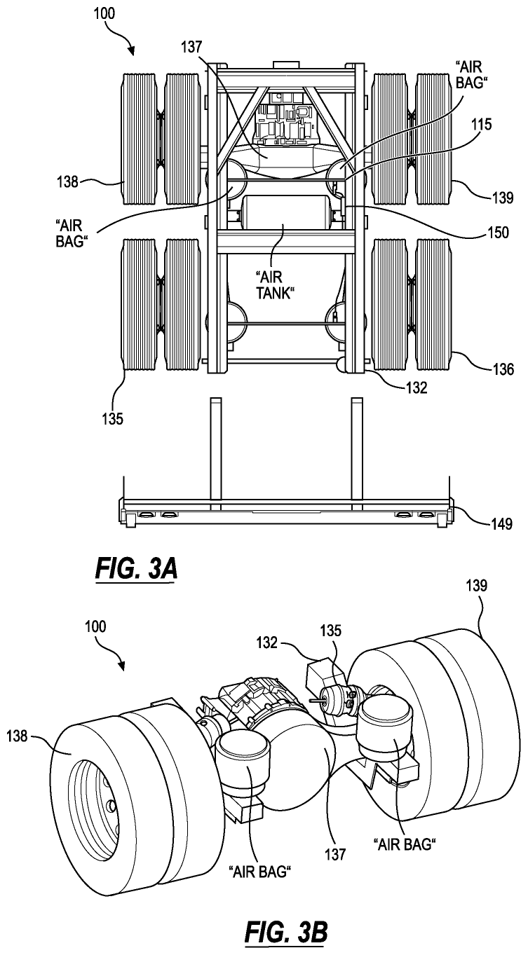

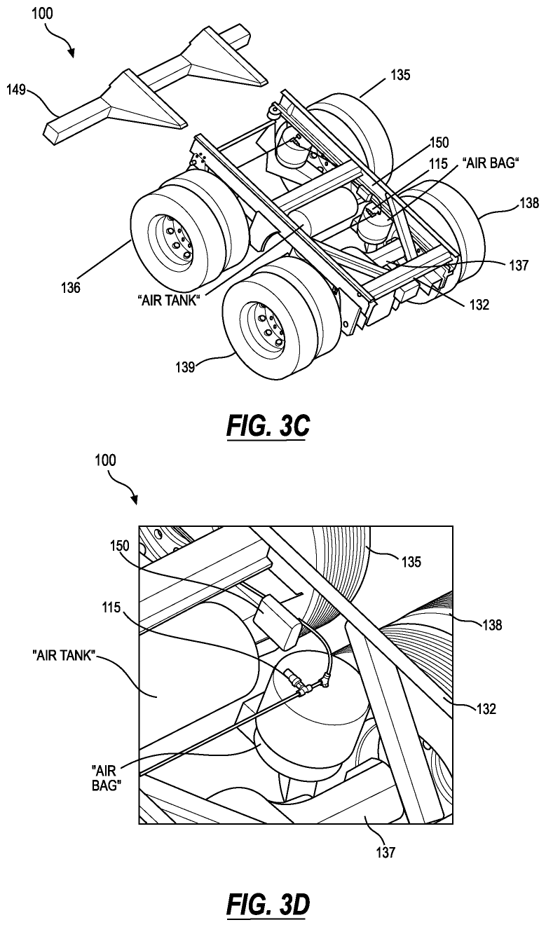

In one variation, as shown in FIGS. 3A and 3B, the bogie 130 can further include an air-ride suspension system coupled to the driven axle 137 and a pressure sensor 115 configured to output signals representing combined air pressures of air bags in the air-ride suspension system. The controller 150 can then leverage these combined air pressures to approximate a weight of the trailer 140 (e.g., a load, a payload) on the driven axle 137 and then selectively trigger the motor 131 to apply positive torque to the driven axle 137 and/or to regeneratively brake the driven axle 137 to (e.g., apply negative torque to the driven axle 137) of the trailer 140 to slow motion of the trailer 140.

For example, the bogie 130 can include an air-ride suspension system coupled to the driven axle 137. The air-ride suspension system includes: a first air bag arranged proximal the left driven wheel 138; and a second air bag arranged proximal the right driven wheel 139. The bogie 130 can further include a pressure sensor 115 coupled to the driven axle 137 and configured to output a signal representing a combined air pressure in the first air bag and the second air bag. The controller 150 can then interface with the integrated controller of the kingpin 110 to: detect a force applied to the kingpin by a hitch of a tow vehicle; detect a direction of motion of the trailer 140 (e.g., forward direction); and access a target preload force. The controller 150 can detect a first combined air pressure in the first air bag and the second air bag based on the signal output by the pressure sensor 115. Then, in response to the first combined air pressure in the first air bag and the second air bag exceeding a threshold air pressure and in response to the first force falling below the target preload force, the controller 150 can: trigger the motor 131 to disable torque output to the driven axle 137; enter a regenerative braking mode; and trigger the motor 131 to supply an electrical energy flux to the battery assembly 120 to regeneratively brake the driven axle 137 in the regenerative braking mode.

In another variation, the controller 150 can: detect an air pressure of an air-ride suspension system coupled to the driven axle 137 (e.g., via a pressure sensor 115); approximate a weight (e.g., a load, a payload) of the trailer 140 on the driven axle 137 based on the air pressure. Further, a user (e.g., an operator, a manager, a driver) can define a threshold weight (e.g., a weight limit, a weight standard) for each driven axle 137 and the controller 150 can leverage this threshold weight to adjust target regenerative braking proportional to the approximated weight of the trailer 140 on the driven axle 137.

For example, the controller 150 can interface with the integrated controller of the kingpin 110 to: detect a force applied to the kingpin by a hitch of a tow vehicle; detect a direction of motion of the trailer 140 (e.g., forward direction); and access a target preload force. The controller 150 can then: interpret a weight of the trailer 140 on the driven axle 137 (e.g., 34,500 pounds) based on the first combined air pressure; and, in response to the weight (e.g., 34,500 pounds) exceeding a threshold weight for the driven axle 137 (e.g., 34,000 pounds) and in response to the force exceeding the target preload force, trigger the set of latches 133 to disengage with corresponding engagement features 144 along the set of rails 147 in an open position; trigger the motor 131 to supply an electrical energy flux to the battery assembly 120 to regeneratively brake the driven axle 137 in the regenerative braking mode to redistribute the weight throughout the trailer 140; and trigger the set of latches 133 to engage corresponding engagement features 144 along the set of rails 147 in a closed position.

Therefore, the controller 150 can interpret air pressures from the air-ride suspension system of the trailer 140 and apply these air pressures to trigger the motor 131 to disable torque output to the driven axle 137 and/or to regeneratively brake the driven axle 137 to adjust the longitudinal position of the bogie 130. Additionally, the controller 150 can leverage these air pressures to interpret a weight of the trailer on the driven axle 137 and trigger the motor 131 to regeneratively brake the driven axle 137 and apply a negative torque to the driven axle 137 to maintain a weight balance of the trailer 140 on the driven axle 137.

### 12. Variation: Service Mode

In one variation, the bogie 130 further includes a secondary battery assembly 122 mounted to the bogie chassis 132 of the bogie 130, and the controller 150 can trigger the secondary battery assembly 122 to supply electrical energy to the motor 131 to assist motion of the bogie 130 away from the trailer 140 and thus, enable a user to service the bogie 130 in a service mode.

For example, a user may wish to service the bogie 130 such as to: replace the motor 131 or the driven axle 137; clean the bogie 130; and/or remove and replace the bogie 130. The user may align the bogie 130 with the distal end 149 of the trailer 140 and manually disengage the set of latches 133 from corresponding engagement features 144 on the set of rails 147. Then, the controller 150 can: detect the set of latches 133 disengaged from the corresponding engagement features 144 on the left rail 147 and on the right rail 147; and, in response to the set of latches 133 disengaging from the corresponding engagement features 144, enter a service mode. In the service mode, the controller 150 can then trigger the secondary battery assembly 122 to supply electrical energy to the motor 131 to output torque to the driven axle 137 to assist motion of the bogie 130 away from the trailer 140 responsive to a user input. The user may then remove the bogie 130 from the floor 146 of the trailer 140 for service and then drive the serviced bogie 130 toward the proximal end 148 of the trailer 140 to engage the set of latches 133 with corresponding engagement features 144 on the set of rails 147. The user may drive the bogie 130 to a target longitudinal position to retain the bogie below the floor 146 of the trailer 140 and manually engage the coupling mechanism to prevent motion of the bogie 130 away from the trailer 140.

### 13. Modular Kit

Generally, the system 100 can include a modular kit 180. The modular kit 180 can be retrofit onto a trailer chassis of an existing trailer to enable detection of conditions of the existing trailer 140 and to selectively transition between operational modes (e.g., a tow mode, a regenerative braking mode, a service mode) according to these conditions.

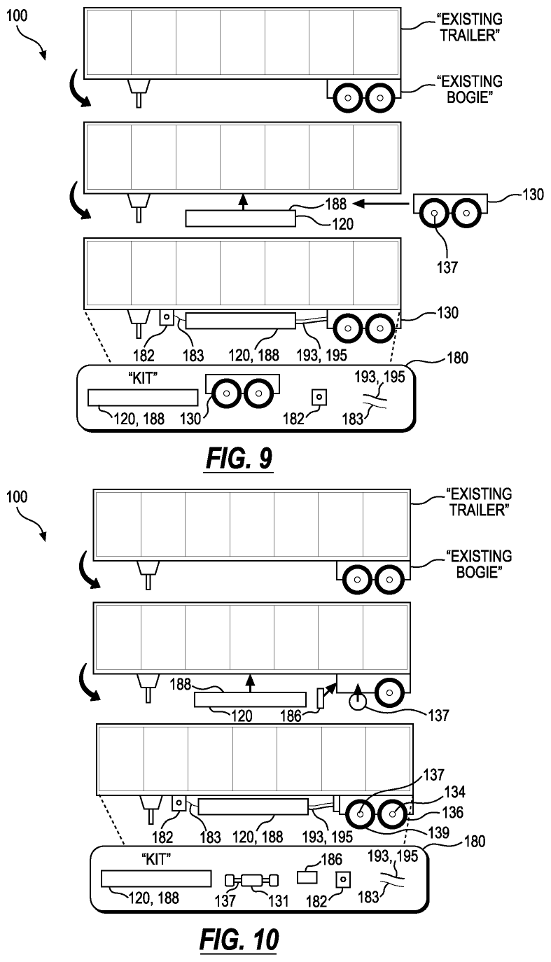

In particular, the modular kit 180 can include a relatively small quantity of (e.g., five or six) components configured to install individually or in combination on various types of existing trailers (e.g., a dry van trailer, a refrigerated trailer) with minimal or no disassembly of or irreversible modification to the existing trailer 140. In one implementation, the modular kit 180 includes: a charge port 182; a bogie module 130; a battery assembly 120; a set of electrical cables 183; a cable carrier 188; and a cooling module 190, as shown in FIG. 9. In another implementation, the modular kit 180 includes: a charge port 182; a motorized axle 137 (i.e., a motor 131 coupled to a driven axle 137); a battery assembly 120; a set of electrical cables 183; an electronics panel 186; a cable carrier 188; and a cooling module 190, as shown in FIG. 10.

### 13.1 Variation: Replacement of Existing Axle

As shown in FIG. 9, the modular kit 180 can include: a charge port 182; a driven axle 137; a motor 131 coupled to the driven axle 137; a battery assembly 120; a set of electrical cables 183; and a cable carrier 188. The charge port 182 is configured to install on a trailer 140 and to receive electrical energy supplied by an external electrical system. The driven axle 137 is configured to install on the bogie chassis 132 supporting a trailer chassis of the trailer 140 and the motor 131 is coupled to the driven axle 137.

The battery assembly 120: includes a set of retention elements 185 configured to transiently engage a set of engagement features 144 on the trailer chassis to couple the battery assembly 120 to the trailer chassis; is configured to receive electrical energy from the charge port 182; is configured to supply electrical energy to the motor 131 to drive the driven axle 137; and is configured to receive electrical energy from the motor 131 to regeneratively brake the driven axle 137. The set of electrical cables 183 are configured to electrically couple the motor 131 and the battery assembly 120.

The cable carrier 188 is configured to: locate between the bogie chassis 132 and the battery assembly 120; house the set of electrical cables 183; and support the set of electrical cables 183 over a range of longitudinal positions of the bogie chassis 132 relative to the battery assembly 120.

### 13.2 Variation: Cooling Module

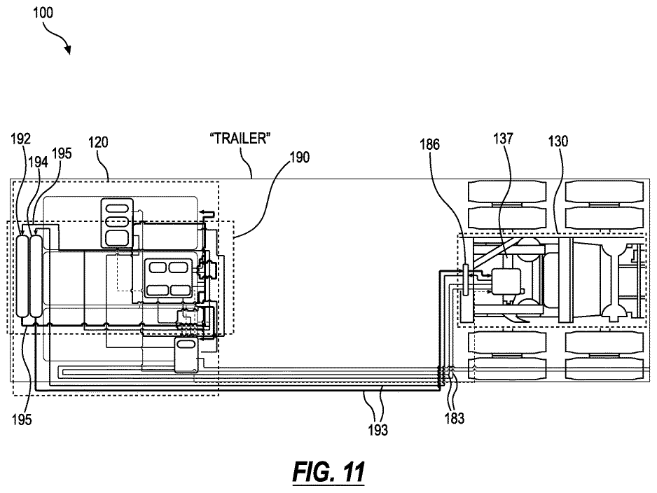

As shown in FIG. 11, the modular kit 180 can include: a driven axle 137; a motor 131 coupled to the driven axle 137; a battery assembly 120; a set of electrical cables 183; a cable carrier 188; and a cooling module 190. The driven axle 137 is configured to install on the bogie chassis 132 supporting a trailer chassis of the trailer 140 and the motor 131 is coupled to the driven axle 137.

The battery assembly 120: includes a set of retention elements 185 configured to transiently engage a set of engagement features 144 on the trailer chassis to couple the battery assembly 120 to the trailer chassis; is configured to receive electrical energy from the charge port 182; is configured to supply electrical energy to the motor 131 to drive the driven axle 137; and is configured to receive electrical energy from the motor 131 to regeneratively brake the driven axle 137. The set of electrical cables 183 is configured to electrically couple the motor 131 and the battery assembly 120.

The cable carrier 188 is configured to: locate between the bogie chassis 132 and the battery assembly 120; house the set of electrical cables 183; and support the set of electrical cables 183 over a range of longitudinal positions of the bogie chassis 132 relative to the battery assembly 120.

The cooling module 190 includes: a first radiator 192 fluidly coupled to the battery assembly 120 via a first coolant loop 193; and a second radiator 194 fluidly coupled to the motor 131.

### 13.3 Variation: Motorized Axle+Battery Assembly+Cable Carrier

As shown in FIG. 11, the modular kit 180 can include: a driven axle 137; a motor 131 coupled to the driven axle 137; a battery assembly 120; a set of electrical cables 183; and a cable carrier 188. The driven axle 137 is configured to install on the bogie chassis 132 supporting a trailer chassis of the trailer 140 and the motor 131 is coupled to the driven axle 137.

The battery assembly 120: includes a set of retention elements 185 configured to transiently engage a set of engagement features 144 on the trailer chassis to couple the battery assembly 120 to the trailer chassis; is configured to receive electrical energy from the charge port 182; is configured to supply electrical energy to the motor 131 to drive the driven axle 137; and is configured to receive electrical energy from the motor 131 to regeneratively brake the driven axle 137. The set of electrical cables 183 is configured to electrically couple the motor 131 and the battery assembly 120.

The cable carrier 188 is configured to: locate between the bogie chassis 132 and the battery assembly 120; house the set of electrical cables 183; and support the set of electrical cables 183 over a range of longitudinal positions of the bogie chassis 132 relative to the battery assembly 120.

### 13.4 Charge Port

The modular kit 180 includes a charge port 182 configured to install on a trailer 140. The charge port 182 is configured to conductively couple to an external electrical system to receive electrical energy supplied by the external electrical system. The controller 150 can then route electrical energy to the battery assembly 120 in a charge mode and thus, charge the battery assembly 120.

In one implementation, the charge port 182 is arranged on a rigid panel and is configured to receive electrical energy supplied by an external electrical system-such as a power source (e.g., electrical grid power) of a depot, a warehouse, or a charging station of a loading dock. The rigid panel can further include a trailer port configured to receive an electrical cable 183 configured to electrically couple the charge port 182 to the battery assembly 120 to charge the battery assembly 120 in a charge mode.

For example, a first electrical cable 183 electrically couples the charge port 182 and the external electrical system, and a second electrical cable 183 electrically couples the trailer port and the battery assembly 120. Accordingly, the charge port 182 can receive electrical energy from the external electrical system via the first electrical cable. The controller 150 can then: distribute electrical energy from the trailer port, through the second electrical cable 183, and to the battery assembly 120 to recharge the battery assembly 120 in a charge mode.

Furthermore, the charge port 182 can exhibit a planar geometry to enable a user to install the charge port 182 below a floor or a trailer chassis of a trailer 140. Alternatively, the modular kit 180 can include a set of charge ports 182 (e.g., a CCS1 charge port, a J3068 charge port) configured to install on the trailer 140. However, the charge port 182 can exhibit any other geometry for installation onto a trailer chassis or a floor of any other type of trailer 140.

### 13.5 Battery Assembly

The battery assembly 120 includes a set of retention elements 185 configured to transiently engage a set of engagement features 144 on the trailer chassis to couple the battery assembly 120 to the trailer chassis. In one variation, the set of retention elements 185 can include a set of brackets (e.g., a hanging bracket) configured to couple to the trailer chassis of the trailer 140. In another variation, the set of retention elements 185 can include a set of latches (e.g., an air pressure latch, a mechanical latch), or a set of solenoids (e.g., an electromechanical solenoid, a pneumatic solenoid), or another electromechanical latch operable in an engaged position and a disengaged position to transiently engage and/or disengage a corresponding engagement feature distributed along a set of rails of a trailer 140, as described above. In another variation, the battery assembly 120 can include a set of clamps 160 configured to couple the battery assembly 120 to a pair of adjacent beams 152 of the trailer 140 to suspend the battery assembly 120 below the floor 146 of the trailer 140, as described above.

### 13.6 Electrical Cables

The set of electrical cables 183 can include a high-voltage power cable, a low-voltage power cable, an anti-lock braking system connection cable, or any other cable to electrically couple the battery assembly 120 and the driven axle 137. The set of electrical cables 183 are configured to run along the trailer chassis and the bogie chassis 132 of the trailer between the driven axle 137 and the battery assembly 120. Each cable 183 defines a length (e.g., 6 feet, 10 feet, 12 feet, 20 feet) proportional to a length of the trailer (e.g., 20 feet, 40 feet, 48 feet, 53 feet, 60 feet). Thus, a user (e.g., an installer, an operator, a fleet manager) may select a set of electrical cables 183 for the modular kit 180 as a function of a length of the trailer (e.g., 20 feet, 40 feet, 48 feet, 53 feet, 60 feet).

Furthermore, first and second ends of the cables 183 are configured to couple to the battery assembly 120 and the driven axle 137 via a set of connectors. For example, the set of connectors can include a set of “quick” connectors (e.g., automotive plastic quick-connects), or a set of dry-brake connectors. Thus, the set of connectors enable a user to repeatably connect and disconnect the set of electrical cables 183 between the battery assembly 120 and the motor 131 or between the battery assembly 120 and an electronics panel 186, as further described below.

### 13.7 Cable Carrier

The cable carrier 188 is configured to: locate between the bogie chassis 132 and the battery assembly 120; house the set of electrical cables 183; and support the set of electrical cables 183 over a range of longitudinal positions of the bogie chassis 132 relative to the battery assembly 120.

In one implementation, the cable carrier 188 includes: a first section configured to extend forward from the bogie chassis; a segmented conduit defining an omegoid profile (e.g., a u-shaped profile); and a spring. The segmented conduit includes a first end configured to couple to the first section of the cable carrier 188 and a second end configured to couple to the battery assembly 120. The segmented conduit is further configured to: coil forward toward a front end of the trailer to accommodate a first distance between the battery assembly 120 and the bogie chassis 132 in a first configuration; and uncoil rearward toward a rear end of the trailer to accommodate a second distance, greater than the first distance, between the battery assembly 120 and the bogie chassis 132 in a second configuration. The spring is configured to: bias the second section toward the first configuration; and release the second section toward the second configuration in response to tension applied to the cable carrier 188.

Thus, the cable carrier 188 can selectively increase or decrease the length of each electrical cable 183 running between the battery assembly 120 and the electronics panel 186 to prevent damage to the cables 183 while the trailer moves away from the bogie module 130 in a service mode or during installation.

### 13.8 Bogie Module

In one implementation, the bogie module 130 includes: a bogie chassis 132; a driven axle 137 suspended from the bogie chassis 132; and a motor 131 coupled to the driven axle 137. The bogie chassis 132 is configured to transiently install on a trailer over a range of longitudinal positions and supports the driven axle 137. The driven axle 137 is supported by an axle housing, suspended from the trailer chassis, and includes a left driven wheel 138 and a right driven wheel 139. The axle housing further encapsulates a motor 131 mounted to the driven axle 137 and is configured to protect the driven axle 137 and the motor 131. The motor 131 is configured to drive the left driven wheel 138 and the right driven wheel 139 and thus, output torque in a tow mode. The motor 131 is further configured to regeneratively brake the left driven wheel 138 and the right driven wheel 139 to slow motion of the trailer 140 and recharge the battery assembly 120 in a regenerative braking mode.

Furthermore, the bogie chassis 132 can be manufactured from a metal such as galvanized steel or stainless steel and coupled to the floor 146 of the trailer 140. Additionally, the bogie chassis 132 can be mounted to the floor 146, such as by welding the bogie chassis 132 to the floor 146 of the trailer 140 or bolting the bogie chassis 132 to the floor 146 of the trailer 140 via a set of fasteners.

The driven axle 137 can further include a suspension system (e.g., a leaf suspension system, a rubber block suspension system, or an air-ride suspension system coupled to the driven axle 137) and a compressed-air-brake system, as described above. The bogie module 130 can further include a set of sensors to collect temperature data. In particular, the set of sensors can include: a set of temperature sensors configured to output signals representing temperatures of the motor 131; and an ambient temperature sensor configured to output signals representing temperatures of the external environment (e.g., ambient air) proximal the motor 131.

### 13.9 Electronics Panel

In one implementation, the modular kit 180 includes an electronics panel 186 (e.g., a bulkhead assembly) and a motorized axle 137 (i.e., a motor 131 coupled to a driven axle 137). The electronics panel 186 is configured to install on the bogie chassis 132. In this implementation, the set of electrical cables 183 is configured to electrically couple the battery assembly 120 to the motor 131 via the electronics panel 186.

Furthermore, the electronics panel 186 includes: a local controller; a suspension pressure sensor configured to fluidly couple to an air-ride suspension system suspending the driven axle 137 from the bogie chassis 132; and a brake pressure sensor configured to fluidly couple to an air brake system arranged on the driven axle 137 or to fluidly couple to an air emergency brake line, arranged proximal the driven axle 137, from the tow vehicle. Each pressure sensor is configured to output signals representing a pressure in the air-ride suspension system, the air brake system, and/or the air emergency brake line. The local controller can then transition between the regenerative braking mode and the maximum regenerative braking mode according to pressures detected by these pressure sensors.

In one variation, the electronics panel 186 includes: a local controller; an inertial sensor (e.g., an IMU, an accelerometer, a gyroscope); a coolant pump 198; and a set of sensors coupled to an anti-locking braking system of the tow vehicle. The local controller can access signals output from sensors coupled to the anti-lock braking system of the tow vehicle to automatically trigger the motor 131 to apply a braking force to the driven axle 137 via the pneumatic or mechanical brake system of the trailer 140 and/or via regenerative braking. Additionally, the local controller can further: access signals output from the set of wheel speed sensors, coupled to the driven axle 137, to track traction between the driven wheels of the driven axle 137 and a ground surface; and trigger the motor 131 to regeneratively brake the driven axle 137, as described above.

### 13.10 Cooling Module

The cooling module 190 includes: a set of radiators 192, 194; a set of valves 196; a set of coolant pumps 198; and a set of coolant loops 193, 195. The set of radiators includes a first radiator 192 fluidly coupled to the battery assembly 120 via a first coolant loop 193 and a second radiator 194 fluidly coupled to the motor 131 via a second coolant loop 195. The first radiator 192 is configured to transfer thermal energy absorbed by coolant flowing through the first coolant loop 193 from the battery assembly 120 to ambient (e.g., ambient environment, external environment). The second radiator 194 is configured to transfer thermal energy absorbed by coolant flowing through the second coolant loop 195 from the motor 131 to ambient.

In one implementation, the coolant module includes: a first radiator 192 fluidly coupled to the battery assembly 120 via a first coolant loop 193; and a second radiator 194 fluidly coupled to the motor 131 via a second coolant loop 195. The first radiator 192 defines: a first coolant inlet configured to receive coolant, outbound from the battery assembly 120, from the first coolant loop 193 at a first temperature; and a first coolant outlet configured to return coolant, at a second temperature less than the first temperature, into the first coolant loop 193 toward the battery assembly 120 to cool the battery assembly 120. The second radiator 194 defines: a second coolant inlet configured to receive coolant, outbound from the motor 131 at a third temperature, from the second coolant loop 195; and a second coolant outlet configured to return coolant, at the second temperature, into the second coolant loop 195 to cool the motor 131 as shown in FIG. 11.

The cooling module 190 can further include a set of fans mounted to the first and second radiators 192, 194, respectively. For example, a first fan is mounted to the first radiator 192 and is configured to dissipate heat from coolant flowing through the first coolant loop 193 from the battery assembly 120 to ambient (e.g., ambient external environment). A second fan is mounted to the second radiator 194 and is configured to dissipate heat from coolant flowing through the second coolant loop 195 from the motor 131 to ambient.

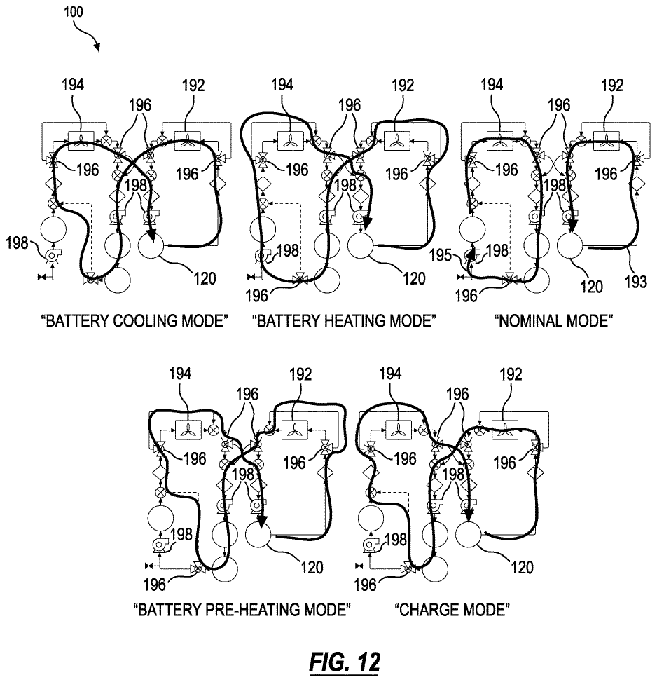

Additionally, the cooling module 190 can include a set of temperature sensors configured to output signals representing temperatures of coolant within the first and second coolant loops 193, 195. The controller 150 can trigger the set of valves 196 to route coolant between the set of radiators 192, 194, the motor 131, and/or the battery assembly 120 to cool or heat the motor 131 and/or the battery assembly 120, as shown in FIG. 12.

### 13.10.1 Radiator Configurations

In one variation, the first radiator 192: is mounted to the trailer chassis; and is fluidly coupled to the battery assembly 120 via the first coolant loop 193. The second radiator 194: is mounted to the trailer chassis interposed between the first radiator and the battery assembly 120; and is fluidly coupled to the motor 131 via the second coolant loop 195.

In another variation, the first radiator 192: is mounted to the trailer chassis proximal the battery assembly 120; and is fluidly coupled to the battery assembly 120 via the first coolant loop 193. The second radiator 194: is mounted to the first radiator 192 to form a vertical stack; and is fluidly coupled to the motor 131 via the second coolant loop 195.

In yet another variation, the first radiator 192 is mounted to the battery assembly 120 and fluidly coupled to the battery assembly 120 via the first coolant loop 193. The second radiator 194 is mounted to the trailer chassis and fluidly coupled to the motor 131 via the second coolant loop 195. In this variation, the first coolant loop 193 includes a first coolant line (e.g., a coolant hose) fluidly coupling the first radiator 192 to the battery assembly 120. The first coolant loop defines: a first end coupled to a coolant inlet of the first radiator 192; and a second end coupled to a coolant outlet of the first radiator 192.

The second coolant loop 195 includes a second coolant line (e.g., a coolant hose) fluidly coupling the second radiator 194 and the motor 131. The second coolant line includes a flexible section supported by and arranged within the cable carrier 188 adjacent segments of the set of electrical cables 183. The flexible section: defines an omegoid profile (e.g., a u-shaped profile); includes a first end configured to couple to the first section of the cable carrier 188; and includes a second end configured to couple to the motor 131. The flexible section is further configured to: coil forward toward a front end of the trailer to accommodate a first distance between the battery assembly 120 and the bogie chassis 132 in a first configuration; and uncoil rearward toward a rear end of the trailer to accommodate a second distance, greater than the first distance, between the battery assembly 120 and the bogie chassis 132 in a second configuration. The spring in the cable carrier 188 is configured to bias the flexible section toward the first configuration and release the flexible section toward the second configuration responsive to tension applied to the cable carrier 188.

Thus, the cable carrier 188 can selectively increase or decrease the length of the second coolant line running between the second radiator 194 and the motor 131 to prevent damage to the second coolant line while the trailer moves relative to the bogie module 130 in a service mode or during installation.

### 13.10.2 Pumps+Valves

The set of coolant pumps 198 can include a coolant pump 198 arranged proximal (e.g., nearby, within a threshold distance of) the battery assembly 120 and configured to circulate coolant between the battery assembly 120 and the first radiator 192. The set of coolant pumps 198 can further include a second coolant pump 198, arranged proximal the motor 131, and configured to circulate coolant between the motor 131 and the second radiator 194. Alternatively, the motor 131 can include an integrated coolant pump 198 configured to circulate coolant between the motor 131 and the second radiator 194.

The set of valves 196 are configured to operate in a set of modes (e.g., a nominal mode, a battery heating mode, a motor heating mode, a battery cooling mode, a motor cooling mode, a charge mode): to selectively fluidly couple the battery assembly 120 to the first radiator 192 and the motor 131 to the second radiator 194 (or neither); to selectively fluidly couple the motor 131 to the first radiator 192 and the second radiator 194; to selectively fluidly couple the battery assembly 120 to the first radiator 192 and the second radiator 194; and to selectively fluidly couple the motor 131 to the first radiator 192, the second radiator 194, and the battery assembly 120.

In one implementation, the set of valves 196 includes a set of three-way valves 196 (e.g., tri-state valves 196) coupled to the first and second coolant loops 193, 195 and configured to route coolant between the first and second coolant loops 193, 195. In another implementation, the set of valves 196 includes a set of four-way valves 196 configured to fluidly couple the first coolant loop 193 and the second coolant loop 195. The set of valves 196 can include electromechanical solenoid valves, rotary valves, ball valves, check valves, gate valves, stop valves, butterfly valves, etc.

### 14. Installation of Modular Kit

In one implementation, an existing trailer 140 includes a trailer chassis, a set of rails coupled to the trailer chassis, a vehicle coupler coupled to a front end of the existing trailer 140, a bogie transiently installed on a rear end of the existing trailer 140, and a set of side skirts (e.g., aerodynamic fairings) installed onto the set of rails. The set of rails can run along a longitudinal axis of the trailer 140, extending parallel to and laterally offset from a longitudinal centerline, to form a channel below the trailer chassis. A user (e.g., a manufacturer, an installer, a fleet manager) may retrofit the modular kit 180 onto the trailer chassis and the set of rails of the existing trailer 140.

### 14.1 Installation of Bogie Module

In one example, the modular kit 180 includes: a charge port 182; a bogie module 130; a battery assembly 120; a set of electrical cables 183; a cable carrier 188; and a cooling module 190.

Furthermore, the user may remove an existing bogie module arranged below the existing trailer 140 and install the battery assembly 120 by: locating the battery assembly 120 below the trailer chassis of the existing trailer; and manually engaging the set of retention elements 185 (e.g., a set of hanging brackets) of the battery assembly 120 with corresponding engagement features 144 on the set of rails to couple the battery assembly 120 to the trailer chassis proximal a front end of the existing trailer 140. The user may then install the bogie module 130 on the existing trailer by: locating the bogie module 130 below the trailer chassis proximal (e.g., nearby, within a threshold distance of) a rear end of the existing trailer; and manually mounting the bogie chassis 132 to the trailer chassis of the existing trailer (or engaging the set of latches 133 with corresponding engagement features 144 on the set of rails) to couple the bogie module 130 to the trailer chassis of the existing trailer 140. The user may: install the charge port 182 under the trailer chassis of the existing trailer proximal the front end of the existing trailer 140, adjacent the vehicle coupler, such that the charge port 182 faces an aperture in a side skirt suspended from the trailer chassis. Thus, the charge port 182 can receive an electrical cable 183 through the aperture in the side skirt from the external electrical system and charge the battery assembly 120 via the electrical cable 183 in a charge mode.

The user may then install a set of electrical cables 183 (e.g., a high-voltage power chain, a low-voltage power chain, an anti-locking braking system connection cable) to electrically couple the charge port 182 to the battery assembly 120, and the battery assembly 120 to the motor 131. The user may further install a set of coolant lines (e.g., a coolant loop, a coolant hose): to fluidly couple a low-temperature radiator, arranged within the cooling module 190 to the battery assembly 120; and to fluidly couple a high-temperature radiator, arranged within the cooling module 190, to the motor 131.

### 14.2 Installation of Driven Axle on Existing Bogie Chassis

In another example, the user (e.g., a manufacturer, an installer) may retrofit the modular kit 180 onto the trailer chassis and an existing bogie chassis arranged below the existing trailer 140. In this example, the modular kit 180 includes: a charge port 182; a motorized axle (i.e., a motor 131 coupled to a driven axle 137); a battery assembly 120; a set of electrical cables 183; a cable carrier 188; an electronics panel 186 (e.g., a bulkhead assembly); and a cooling module 190. The user may remove a front axle from the existing bogie chassis and replace the front axle with the motorized axle (i.e., a motor 131 coupled to the driven axle 137).

The user may then mount the electronics panel 186 (e.g., a bulkhead assembly)-housing a local controller 150 and a set of sensors-to the existing bogie chassis. The user may install the battery assembly 120 by: locating the battery assembly 120 below the trailer chassis of the existing trailer; and manually engaging a set of retention elements 185 of the battery assembly 120 with corresponding engagement features 144 on a set of rails to couple the battery assembly 120 to the trailer chassis of the existing trailer 140. The user may mount the charge port 182 to the trailer chassis of the existing trailer proximal a front end of the existing trailer 140, adjacent the vehicle coupler, such that the charge port 182 faces an aperture in a side skirt suspended from the existing trailer 140. The user may further install the cooling module 190 proximal the battery assembly 120.

Accordingly, the user may then: connect an electrical cable 183 between the charge port 182 and the battery assembly 120; and connect the set of electrical cables 183 to the battery assembly 120 and the electronics panel 186. The user may further install a set of coolant lines (e.g., a coolant loop, a coolant hose): to fluidly couple a low-temperature radiator, arranged within the cooling module 190, to the battery assembly 120; and to fluidly couple a high-temperature radiator, arranged within the cooling module 190, to the motor 131.

### 14.3 Example Configurations

Generally, a user (e.g., a manufacturer, an installer, a fleet manager) or machine may select a modular kit 180 for installation below a floor of an existing trailer as a function of a type of the existing trailer (e.g., a dry van trailer, a refrigerated trailer), a length of the existing trailer (e.g., 20 feet, 40 feet, 48 feet, 53 feet, 60 feet), and/or a weight distribution of the existing trailer 140.

In one example, a user selects a modular kit 180 containing: a charge port 182; a battery assembly 120; a bogie module 130; and a cable carrier 188. The user: arranges the charge port 182 below the trailer chassis proximal a front end of the existing trailer; manipulates the bogie chassis 132 along a longitudinal axis of the existing trailer to arrange the bogie module 130 below the trailer chassis proximal a rear end of the existing trailer; locates the battery assembly 120, interposed between the front end of the existing trailer 140 and the bogie module 130; and arranges the cable carrier 188 between the bogie chassis and the battery assembly 120.

In another example, the user selects a modular kit 180 containing: a charge port 182; a motorized axle 137 (e.g., a motor 131 coupled to a driven axle 137); a battery assembly 120; an electronics panel 186; and a cooling module 190. The user then: arranges the charge port 182 below the trailer chassis on a front end of the existing trailer; locates and installs the driven axle 137 below the existing bogie chassis proximal a rear end of the existing trailer; couples the electronics panel 186 to the trailer chassis, proximal the driven axle 137; arranges the battery assembly 120 interposed between the front end and the driven axle 137; and arranges the cooling module 190 below the trailer chassis interposed between the front end of the existing trailer 140 and the battery assembly 120.

Thus, a user may select and install (e.g., retrofit) a limited quantity of components from the modular kit 180 onto an existing trailer according to a gross weight limit of the existing trailer 140, a target weight distribution of the existing trailer 140, and/or a type of existing trailer 140.

### 15. Thermal Energy Management

Generally, the controller 150, integrated into the cooling module 190, can augment heating and cooling of the motor 131 and the battery assembly 120 to maintain the motor 131 and the battery assembly 120 within operating temperature ranges and thus reduce fuel or electrical energy consumed by a tractor hauling the trailer 140. In particular, the controller 150 can: monitor temperatures of the battery assembly 120 and the motor 131 (e.g., via temperature sensors); and trigger the set of valves 196 to route coolant between the set of radiators, the motor 131, and/or the battery assembly 120 to cool or heat the motor 131 and/or the battery assembly 120. For example, the controller 150 can cooperate with the set of valves 196 to direct thermal energy from the motor 131 to the battery assembly 120 to pre-heat the battery assembly 120 while the trailer is docked and prior to entering a tow mode.

Furthermore, the controller 150 can access an operating temperature range for the battery assembly 120, specified by a manufacturer. The controller 150 can further access a second operating temperature range for the motor 131, specified by a manufacturer. In one variation, a user may define a battery temperature range for the battery assembly 120 and a motor temperature range for the motor 131 via a user interface. The controller 150 can then retrieve the battery temperature range and the motor temperature range from the user interface. In another variation, the controller 150 can track the temperature of the battery assembly 120 and the motor 131 over time via the temperature sensors while a tow vehicle hauling the trailer executes a drive route. The controller 150 can then: calculate an average temperature of the battery assembly during the drive route; and define a battery temperature range within a tolerance range (e.g., a tolerance range of +/−five degrees, +/−two degrees) of the average temperature of the battery assembly 120. The controller 150 can repeat these methods and techniques for the motor 131 to define a motor temperature range.

### 15.1 Nominal Mode

In one implementation, the controller 150 transitions the set of valves 196 to a nominal mode: to direct coolant from the first radiator 192 to the battery assembly 120; and to direct coolant from the second radiator 194 to the motor 131 to cool the battery assembly 120 and the motor 131.

In one variation, the controller 150: detects temperatures of the battery assembly 120 and the motor 131 via temperature sensors; and transitions the set of valves 196 to the nominal mode according to the temperatures of the battery assembly 120 and the motor 131. For example, the controller 150 can: receive a first signal output by a temperature sensor arranged within the battery assembly 120; receive a second signal output by a temperature sensor arranged proximal the motor 131; interpret a first temperature of the battery assembly 120 based on the first signal; and interpret a second temperature of the battery assembly 120 based on the second signal.

Then, in response to the first temperature of the battery assembly falling within a battery temperature range and in response to the second temperature of the motor falling within the motor temperature range, the controller 150 can trigger the set of valves 196 to transition to the nominal mode. In the nominal mode, the set of valves 196 can: route a first volume of coolant through the first coolant loop 193 to dissipate heat from the battery assembly 120 to ambient; and route a second volume of coolant through the second coolant loop 195 to dissipate heat from the motor 131 to ambient.

Therefore, the controller 150 can trigger the set of valves 196 to transition to the nominal mode to isolate the first coolant loop 193 from the second coolant loop 195. The controller 150 further cooperates with the set of valves 196 to maintain temperatures of the battery assembly 120 and the motor 131 within operating temperature ranges by: selectively directing coolant, in the first coolant loop 193, to the battery assembly 120; and selectively directing coolant, in the second coolant loop 195, to the motor 131.

### 15.2 Battery Heating Mode+Motor Heating Mode

In one implementation, the controller 150 triggers the set of valves 196 to direct thermal energy, absorbed by the coolant, from the motor 131 to the battery assembly 120 and thus, heat the battery assembly 120 in a battery heating mode. Alternatively, the controller 150 triggers the set of valves 196 to direct thermal energy, absorbed by the coolant, from the battery assembly 120 to the motor 131 and thus, heat the motor 131 in a motor heating mode.

In one variation, the controller 150 implements methods and techniques described above to interpret a first temperature of the battery assembly 120 and a second temperature of the motor 131 via the set of temperature sensors. Then, in response to the first temperature of the battery assembly 120 exceeding the battery temperature range, and in response to detecting the second temperature of the motor 131 falling within the motor temperature range, the controller 150 triggers the set of valves 196 to transition to the battery heating mode. In the battery heating mode, the set of valves 196 is configured to: intermix the first volume of coolant and the second volume of coolant; and route coolant from the motor 131 to the battery assembly 120 to heat the battery assembly 120. In one example, in the battery heating mode, the set of valves 196 is configured to: fluidly couple the battery assembly 120 to the motor 131; intermix the first volume of coolant and the second volume of coolant; and route coolant from the motor 131 to the battery assembly 120 while bypassing the first radiator 192 and the second radiator 194. In another example, the set of valves 196 is configured to: fluidly couple the battery assembly 120 to the motor 131; intermix the first volume of coolant and the second volume of coolant; and route coolant from the motor 131 to the battery assembly 120 while bypassing the second radiator 194, as shown in FIG. 12.

Alternatively, in response to the first temperature of the battery assembly falling within the battery temperature range, and in response to the second temperature of the motor falling below the motor temperature range, the controller 150 can trigger the set of valves 196 to transition to the battery heating mode. In the battery heating mode, the set of valves 196 is configured to: intermix the first volume of coolant and the second volume of coolant; and route coolant from the battery assembly 120 to the motor 131 to heat the motor 131.

Therefore, the controller 150 can monitor temperatures of the battery assembly 120 and the motor 131 and selectively trigger the set of valves 196 to transition to the battery heating mode or the motor heating mode. Additionally, the controller 150 can trigger the set of valves 196 to direct thermal energy, absorbed by coolant flowing through the first and second coolant loops 193, 195 to the battery assembly 120 in the battery heating mode or to the motor 131 in the motor heating mode.

### 15.3 Battery Cooling Mode+Motor Cooling Mode

In one implementation, in a battery cooling mode, the controller 150 triggers the set of valves 196 to direct coolant from the first radiator 192 and the second radiator 194 to the battery assembly 120 to cool the battery assembly 120. Alternatively, in a motor 131 cooling mode, the controller 150 triggers the set of valves 196 to direct coolant from the first radiator 192 and the second radiator 194 to the motor 131. Further, the controller 150 triggers the set of valves 196 to a set of positions to direct coolant from the battery assembly 120 or the motor 131 to the first radiator 192 and the second radiator 194.

In one variation, the controller 150 implements methods and techniques described above to detect a first temperature of the battery assembly 120 and detect a second temperature of the motor 131. Then, in response to the first temperature of the battery assembly 120 exceeding the battery temperature range and in response to the second temperature of the motor 131 falling below the motor temperature range, the controller 150 transitions the set of valves 196 to the battery cooling mode. In the battery cooling mode, the set of valves 196 is configured to: route the first volume of coolant from the first radiator 192 to the battery assembly 120; and route the second volume of coolant from the second radiator 194 to the battery assembly 120 to cool the battery assembly 120.

Alternatively, in response to the first temperature of the battery assembly 120 falling below the battery temperature range and in response to the second temperature of the motor 131 exceeding the motor temperature range, the controller 150 can: transition the set of valves 196 to a motor cooling mode. In the motor cooling, the set of valves 196 are configured to: route the first volume of coolant from the first radiator 192 to the motor 131; and route the second volume of coolant to the motor 131 while bypassing the second radiator 194 to cool the motor 131.

Therefore, in the battery cooling mode, the controller 150 can trigger the set of valves 196 to direct coolant from the first radiator 192 and the second radiator 194 to rapidly cool the battery assembly 120. Additionally, in the motor cooling mode, the controller 150 can cooperate with the set of valves 196 to direct coolant from the first radiator 192 to rapidly cool the motor 131.

### 16. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A kit comprising:
a battery assembly:
configured to install on a trailer; and
comprising:
a set of cross members;
a set of batteries arranged between the set of cross members;
a set of clamps, each clamp in the set of clamps:
coupled to a cross member in the set of cross members; and
cooperating to suspend the battery assembly below the trailer; and
a set of fasteners, each fastener in the set of fasteners configured to:
rotate in a first direction to:
orient a clamp, in the set of clamps, orthogonal to a pair of adjacent beams supporting a floor of the trailer; and
draw the clamp downwardly toward a cross member in the set of cross members:
to pinch lower flanges of the pair of adjacent beams between the clamp and the cross member; and
to couple the battery assembly to the trailer; and
rotate in a second direction, opposite the first direction, to:
raise the clamp upwardly from the cross member;
release lower flanges of the pair of adjacent beams from the clamp and the cross member to decouple the battery assembly from the trailer; and
orient the clamp parallel to the pair of adjacent beams.

2. The kit of claim 1, wherein each clamp in the set of clamps is configured to:
rotate from a disengaged position parallel to a pair of adjacent beams to an engaged position orthogonal to the pair of adjacent beams responsive to rotation of a fastener, in the set of fasteners, in the first direction;
couple the battery assembly to the pair of adjacent beams while oriented orthogonal to the pair of adjacent beams; and
rotate from the engaged position to the disengaged position, responsive to rotation of the fastener in the second direction, to permit passage of the clamp between a gap defined between the pair of adjacent beams.

3. The kit of claim 1, wherein each clamp in the set of clamps:
comprises:
a first end; and
a second end opposite the first end; and
is configured to:
pivot about a midpoint between the first end and the second end to orient the first end proximal a first lower flange of a first beam in a pair of adjacent beams and the second end proximal a second lower flange of a second beam in the pair of adjacent beams; and
pinch the first lower flange between the first end and a cross member and the second lower flange between the second end and the cross member.

4. The kit of claim 1, wherein the set of clamps comprises a first clamp:
arranged proximal a first upper surface of a first cross member in the set of cross members;
configured to:
rotate from a disengaged position parallel to a first pair of adjacent beams to an engaged position orthogonal to the first pair of adjacent beams responsive to rotation of a first fastener, in the set of fasteners, in the first direction; and
couple the battery assembly to the pair of adjacent beams while oriented orthogonal to the pair of adjacent beams; and
comprising a first stop:
extending from the first clamp toward the first upper surface of the first cross member; and
configured to abut the first cross member responsive to rotation of
the first clamp by a first rotational offset to retain the first clamp orthogonal to the first pair of adjacent beams.

5. The kit of claim 1, wherein the set of clamps comprises a first clamp:
arranged proximal a first upper surface of a first cross member in the set of cross members;
configured to couple the battery assembly to a first pair of adjacent beams of the trailer; and
comprising:
a first end contacting a first lower flange of a first beam in the first pair of adjacent beams;
a second end, opposite the first end, contacting a second lower flange of a second beam in the first pair of adjacent beams;
a midsection:
arranged between the first end and the second end;
spanning a first gap defined between the first pair of adjacent beams;
offset above the first upper surface of the first cross member; and
configured to receive a first fastener in the set of fasteners; and
a first spacer:
interposed between the first upper surface of the first cross member and the midsection; and
configured to distribute a clamping force of the first fastener across the midsection.

6. The kit of claim 1:
wherein the set of fasteners comprises a first fastener configured to:
extend through a first cross member in the set of cross members;
engage a first nut of a first clamp in the set of clamps; and
rotate the first clamp and the first nut responsive to rotation of the first fastener about a longitudinal axis of the first fastener; and
wherein the battery assembly further comprises a first friction element:
interposed between the first fastener and the first nut; and
configured to engage a first set of threads of the first fastener to maintain contact between the first fastener and the first nut while the first fastener rotates.

7. The kit of claim 1, wherein the set of clamps comprises a first clamp:
arranged proximal a first cross member in the set of cross members;
configured to couple the battery assembly to a first pair of adjacent beams of the trailer; and
comprising:
a first end arranged proximal a first lower flange of a first beam in the first pair of adjacent beams; and
a first plate:
arranged proximal the first end; and
exhibiting a first dimension exceeding a nominal dimension of the first end; and
configured to:
pinch the first lower flange between the first clamp and the first cross member; and
distribute a clamping force of the first clamp across the first plate.

8. The kit of claim 1:
wherein the set of clamps comprises a first clamp arranged proximal a first cross member in the set of cross members; and
wherein the battery assembly further comprises a first compliant element:
interposed between the first cross member and the set of batteries; and
configured to deform responsive to twisting of the trailer to isolate the set of batteries from forces transmitted to the first cross member via the set of clamps.

9. The kit of claim 1, wherein the set of clamps comprises a first clamp:
arranged proximal a first cross member in the set of cross members;
comprising:
a first end; and
a second end opposite the first end; and
configured to:
in a first configuration:
pinch a first lower flange of a first beam, in a first pair of adjacent beams of the trailer, between the first end and the first cross member, the first pair of adjacent beams exhibiting a first flange geometry; and
pinch a second lower flange of a second beam, in the first pair of adjacent beams; between the second end and the first cross member; and
in a second configuration:
pinch a third lower flange of a third beam, in a third pair of adjacent beams of a third trailer, between the first end and the first cross member, the third pair of adjacent beams exhibiting a third flange geometry different from the first flange geometry; and
pinch a fourth lower flange of a fourth beam, in the third pair of adjacent beams, between the second end and the first cross member.

10. The kit of claim 1:
wherein the set of cross members comprises a first cross member defining a first aperture extending through the first cross member;
wherein the set of clamps comprises a first clamp:
arranged proximal the first cross member; and
comprising a first nut aligned with the first aperture; and
wherein the set of fasteners comprises a first fastener configured to:
extend vertically through the first aperture;
engage the first nut; and
rotate the first nut and the first clamp in a plane orthogonal to a longitudinal axis of the first fastener to couple the first clamp to a first pair of adjacent beams without manual positioning of the first clamp.

11. The kit of claim 1, wherein the set of clamps comprises a first clamp:
arranged proximal a first cross member in the set of cross members;
operable in:
a disengaged position with the first clamp oriented parallel to a first pair of adjacent beams; and
an engaged position with the first clamp:
oriented orthogonal to the first pair of adjacent beams; and
pinching a lower flange of each beam, in a pair of adjacent beams, between the first clamp and the first cross member to couple the battery assembly to the first pair of adjacent beams; and
comprising:
a first stop configured to abut the first cross member responsive to rotation of the first clamp by a first rotational offset to retain the first clamp in the engaged position; and
a first spring configured to bias the first clamp toward the disengaged position.

12. The kit of claim 1:
wherein the set of cross members comprises a first cross member comprising:
a first stop protruding from a first upper surface of the first cross member; and
wherein the set of clamps comprises a first clamp:
arranged proximal the first cross member;
configured to couple the battery assembly to a first pair of adjacent beams of the trailer while oriented orthogonal to the first pair of adjacent beams; and
configured to abut the first stop responsive to rotation of the first clamp by a first rotational offset to retain the first clamp orthogonal to the first pair of adjacent beams.

13. The kit of claim 1:
further comprising a second battery assembly arranged proximal the battery assembly;
wherein the set of cross members comprises:
a first cross member; and
a second cross member, opposite the first cross member, proximal the second battery assembly;
wherein the set of batteries is interposed between the first cross member and the second cross member; and
wherein the set of clamps comprises:
a first clamp pivotably coupled to the first cross member; and
a second clamp:
pivotably coupled to the second cross member and a third cross member of the second battery assembly; and
configured to cooperate with the first clamp to couple the battery assembly and the second battery assembly to the trailer.

14. The kit of claim 1:
further comprising:
a driven axle configured to install on the trailer; and
a motor coupled to the driven axle and configured to:
output torque to the driven axle; and
regeneratively brake the driven axle; and
wherein the battery assembly is configured to:
supply electrical energy to the motor to drive the driven axle; and
receive electrical energy from the motor during regenerative braking of the driven axle by the motor.

15. A kit comprising:
a driven axle configured to install on a trailer;
a motor coupled to the driven axle; and
a battery assembly:
configured to install on the trailer; and
comprising:
a set of cross members;
a set of batteries arranged between the set of cross members;
a set of clamps, each clamp in the set of clamps:
coupled to a cross member in the set of cross members; and
configured to couple the battery assembly to a pair of adjacent beams of the trailer to suspend the battery assembly below the trailer; and
a set of fasteners, each fastener in the set of fasteners configured to:
extend through a cross member in the set of cross members; and
couple a clamp, in the set of clamps, to the cross member.

16. The kit of claim 15, wherein each fastener in the set of fasteners is configured to:
rotate in a first direction to:
orient a clamp, in the set of clamps, orthogonal to a pair of adjacent beams supporting a floor of the trailer; and
draw the clamp downwardly toward a cross member in the set of cross members:
to pinch lower flanges of the pair of adjacent beams between the clamp and the cross member; and
to couple the battery assembly to the trailer; and
rotate in a second direction, opposite the first direction, to:
raise the clamp upwardly from the cross member;
release lower flanges of the pair of adjacent beams from the clamp and the cross member to decouple the battery assembly from the trailer; and
orient the clamp parallel to the pair of adjacent beams.

17. The kit of claim 15, wherein the set of clamps comprises a first clamp:
arranged proximal a first upper surface of a first cross member in the set of cross members;
configured to couple the battery assembly to a first pair of adjacent beams of the trailer; and
comprising a first spacer:
interposed between the first upper surface of the first cross member and a first lower surface of the first clamp; and
configured to distribute a clamping force of a first fastener, in the set of fasteners, across the first clamp.

18. The kit of claim 15, wherein the set of clamps comprises a first clamp:
comprising:
a first end; and
a second end opposite the first end; and
configured to:
pinch a first lower flange of a first beam, in a first pair of adjacent beams of the trailer, between the first end and a first cross member in the set of cross members; and
pinch a second lower flange of a second beam, in the first pair of adjacent beams, between the second end and the first cross member.

19. A battery assembly comprising:
a set of cross members;
a set of batteries:
arranged between the set of cross members; and
configured to:
supply electrical energy to a motor of a trailer to drive a driven axle of the trailer; and
receive electrical energy from the motor during regenerative braking of the driven axle by the motor;
a clamp:
coupled to a cross member in the set of cross members; and
configured to couple the battery assembly to a pair of adjacent beams of the trailer to suspend the battery assembly below the trailer; and
a fastener configured to:
extend through the cross member and into a nut of the clamp; and
rotate the nut and the clamp in a plane orthogonal to a longitudinal axis of the fastener to couple the clamp to a pair of adjacent beams of the trailer.

20. The battery assembly of claim 19:
wherein the fastener is configured to:
rotate in a first direction to:
orient the clamp orthogonal to the pair of adjacent beams supporting a floor of the trailer; and
draw the clamp downwardly toward the cross member:
to pinch lower flanges of the pair of adjacent beams between the clamp and the cross member; and
to couple the battery assembly to the trailer; and
rotate in a second direction, opposite the first direction, to:
raise the clamp upwardly from the cross member;
release lower flanges of the pair of adjacent beams from the clamp and the cross member to decouple the battery assembly from the trailer; and
orient the clamp parallel to the pair of adjacent beams.
